(19) United States
(12) Patent Application Publication
(10) Pub. No.: US 2011/0043623 A1
(43) Pub. Date: Feb. 24, 2011

(54) IMAGING DEVICE

(75) Inventors: Yasunari Fukuta, Hachioji-shi (JP); Akira Fukushima, Tondabayashi-shi (JP); Miyuki Teramoto, Osakasayama-shi (JP); Keiji Matsusaka, Osaka-shi (JP)

Correspondence Address: SIDLEY AUSTIN LLP, 717 NORTH HARWOOD, SUITE 3400, DALLAS, TX, 75201, US

(73) Assignee: Konica Minolta Opto, Inc., Hachioji-shi, Tokyo (JP)

(21) Appl. No.: 12/934,062

(22) PCT Filed: Mar. 16, 2009
(86) PCT No.: PCT/JP2009/055052

§ 371 Date: Sep. 22, 2010

(30) Foreign Application Priority Data
Mar. 26, 2008 (JP) 2008-081538

(51) Int. Cl. H04N 7/18; H04N 5/225

(52) U.S. Cl. 348/135; 348/222.1; 348/E07.085; 348/E05.024

(57) ABSTRACT

A mode control section controls an image generation section to operate in a normal mode or a polarized light component reduction mode on the basis of a mode signal from a mode signal generation section to cause the image generation section to form a normal image or a polarized light component reduced image. When the possibility of occurrence of stray light is high, the imaging device automatically switches to the polarized light component reduction mode and when the possibility of occurrence of the stray light is low, the imaging device automatically switches to the normal mode. The polarized light component reduced image is obtained by reducing or eliminating stray light having a polarized light component, and the normal image is formed without reducing the stray light. Thus, the imaging device is capable of automatically switching between the two modes.

### RELATED APPLICATIONS

This application is a U.S. National Phase Application under 35 U.S.C. 371 of International Application No. PCT/JP2009/055052, filed. Mar. 16, 2009, which claims priority to Japanese Patent Application No. 2008-081538, filed Mar. 26, 2008.

### TECHNICAL FIELD

The present invention relates to an imaging device capable of generating a normal image and a polarized light component reduced image in which a specific polarized light component is eliminated or reduced.

### BACKGROUND ART

Over recent years, cameras have been mounted in various apparatuses such as vehicles or robots.

When imaging is carried out using a camera, if a relatively intense light source exists in a photographed image plane or in the vicinity of the photographed image plane, when a light beam passes through an optical system, the light beam may reflect on the lens surface of the optical system, an optical flat plate, or a lens barrel without passing through a light beam passing position expected by design, resulting in occurrence of stray light. In such a case, when this stray light reaches an imaging element, an image of the light source may be formed on a position where no image is normally formed, or information of an image which is desired to be formed may be lost. Especially in the case of imaging at night, when this stray light falls on the imaging element, it is noticeable. Further, when image information is relatively important, for example, in a car-mounted camera, a monitoring camera, or a measurement camera and when this stray light reaches the imaging element, normal image information is lost, resulting in a more critical problem.

Therefore, it is desirable that stray light having reached an imaging element be reduced. However, for example, when an image signal output from the imaging element is subjected to image processing and thereby stray light having reached the imaging element is reduced, reduction thereof may be difficult to carry out or an unnatural image may be obtained from the reduction.

Further, in cases in which stray light is always reduced, even under a situation without stray light, polarized light information is lost, whereby normal image information is also lost in an undesirable manner Namely, on one hand, by reduction of the stray light, normal image information can be obtained. On the other hand, normal image information under a situation without stray light is lost. Therefore, it is desirable to control, depending on the situation, whether to reduce stray light or not.

On the other hand, Patent Document 1 discloses a technology referred to as polarization imaging According to the technology disclosed in Patent Document 1, an image, of a windowpane and the like, containing a polarized light component can be prevented from being formed. However, in Patent Document 1, no disclosure is made with respect to control of whether to reduce stray light or not, depending on situations. Further, nothing is suggested therein.

Patent Document 1: Unexamined Japanese Patent Application Publication No. 2007-086720

### DISCLOSURE OF THE INVENTION

### Object of the Invention

In view of the above circumstances, the present invention was completed. An object thereof is to provide an imaging device enabling to automatically switch whether or not stray light is reduced depending on the situation.

### Means for Solving the Object

An object of the invention is achieved by the following configurations.

Item 1. An imaging device, comprising:

an imaging section configured to have an linear polarization section and to pick up an optical image having a polarized light component having reduced;

an image processing section configured to form an image corresponding to the optical image, based on an output of the imaging section;

a mode signal generation section configured to generate a mode signal for determining a mode of the image to be formed in the image processing section; and

a mode control section configured to control the image processing section:
to separate a non-polarized light component from the output of the imaging section and to form a polarized light component reduced image based on the separated non-polarized light component when the mode signal of the mode signal generation section is judged to be a polarized light component reduction mode; and
to form a normal image based on the output of the imaging section without separating the non-polarized light component from the output of the imaging section when the mode signal of the mode signal generation section is judged to be a normal mode.

Item 2. The imaging device of item 1, wherein the mode signal generation section includes an optical sensor for detecting an amount of external light, and the mode control section judges:

that an output value of the optical sensor indicates the polarized light component reduction mode when the output value is less than the predetermined threshold value; and

that the output value of the optical sensor indicates the normal mode when the output value is not less than the predetermined threshold value.

Item 3. The imaging device of item 1, wherein the mode signal generation section includes a clock section for counting time, and the mode control section judges:

that an output value of the clock section indicates the polarized light component reduction mode when the output value is outside a predetermined time zone; and

that the output value of the clock section indicates the normal mode when the output value is within the predetermined time zone.

Item 4. The imaging device of item 1, wherein the mode signal generation section includes the imaging section, and the mode control section judges:

that an output value of the imaging section indicates the polarized light component reduction mode when the output value is less than the predetermined threshold value; and

that the output value of the imaging section indicates the normal mode when the output value is not less than the predetermined threshold value.

Item 5. The imaging device of item 1, wherein the imaging section includes:

an imaging optical system configured to form an optical image on a predetermined image plane;

a plurality of liner polarizers provided at a position on an optical axis of the imaging optical system to allow incoming light to pass therethrough and emit therefrom with respect to a plurality of transmission axes which are different from each other;

an imaging element on a light receiving surface of which the optical image is allowed to be formed, and which is configure to convert the optical image into an electrical signal.

Item 6. The imaging device of item 1, wherein the linear polarization section includes a plurality of linear polarizers on the same plane, and the linear polarizers have different transmission axes.

Item 7. The imaging device of item 6, wherein one of the plurality of linear polarizes is constituted by a photonic crystal.

Item 8. The imaging device of claim 1, wherein the imaging optical system is provided with a thin film whose p-polarization reflectance and s-polarization reflectance are different, on an upstream side in a progressing direction of light from the plurality of linear polarizers.

Item 9. The imaging device of item 8, wherein the thin film is disposed on a surface on which a strong stray light which reaches the imaging element is reflected.

Item 10. The imaging device of item 8, wherein the imaging optical system includes at least a lens, and the thin film is disposed on the lens and satisfies the following conditional expressions (1) and (2):

1 [%]≦Rs(α)−Pp(α) (1)

40 [°]<α<60 [°] (2)

where:

α [°] is an incidence angle of light with respect to the thin film;

Rs(α) [%] is an s-polarization reflectance of the thin film when entering the thin film at the incidence angle α [°] of light; and

Rp(α) [%] is a p-polarization reflectance of the thin film when entering the thin film at the incidence angle α [°] of light.

Item 11. The imaging device item 8, wherein the thin film satisfies the following conditional expression (3) at a reference wavelength of the imaging element:

Rp(50)<1.5 [%] (3)

where:

Rp(50) [%] is a p-polarization reflectance of the thin film when entering the thin film at the incidence angle α [°] of light.

Item 12. The imaging device of item 8, wherein the p-polarization reflectance of the thin film satisfies the following conditional expressions (3) in a wavelength range of 450 nm to 650 nm:

Rp(50)<1.5 [%] (3)

where:

Rp(50) [%] is a p-polarization reflectance of the thin film when entering the thin film at the incidence angle α [°] of light.

Item 13. The imaging device of item 6, wherein the imaging element and the linear polarizer constitute a polarization imaging system, being stacked to each other in an integrated manner.

Item 14. The imaging device of item 1, wherein the imaging section is one of a car-mounted camera, a surveillance camera, and a measurement camera.

### Advantage of the Invention

According to the present invention, based on a mode signal of a mode signal generation section, a mode control section causes an image generation section to operate in the normal mode or in the polarized light component reduction mode to form a normal image or a polarized light component reduced image in the image generation section. Therefore, when imaging is carried out in the situation where stray light having a polarized light component is likely generated in the imaging device, namely, when stray light is likely to occur, the imaging device is automatically switched to the polarized light component reduction mode, whereby a polarized light component reduced image, in which occurrence of stray light having a polarized light component is reduced or eliminated, is formed. In contrast, when stray light is unlikely to occur, the imaging device is automatically switched to the normal mode, whereby a normal image, which is more natural than the polarized light component reduced image, is formed. Thus, an imaging device capable of automatically switching, depending on the situation, whether to reduce stray light or not can be provided.

### BRIEF DESCRIPTION OF THE DRAWINGS

FIG. 1 is a block diagram showing a constitution of an imaging device of an embodiment;

FIG. 2 is a view showing a constitution of a polarization imaging system;

FIGS. 3A and 3B are views illustrating the intensity fm(i,j) of transmitted light received by a polarization imaging device;

FIG. 4 is a block diagram showing a constitution to describe an imaging device of a third embodiment;

FIG. 5 is a sectional view of a lens schematically showing a constitution to describe an imaging section and an optical system thereof of a fourth embodiment;

FIG. 6 is a sectional view of a lens schematically showing a constitution to describe an imaging section and an optical system thereof of a fifth embodiment;

FIG. 7 is a sectional view of a lens schematically showing a constitution to describe an imaging section and an optical system thereof of a sixth embodiment;

FIG. 8 is a sectional view of a lens schematically showing a constitution to describe an imaging section and an optical system thereof of a seventh embodiment;

FIG. 9 is a sectional view of a lens schematically showing a constitution to describe an imaging section and an optical system thereof of an eighth embodiment;

FIG. 10 is a sectional view of a lens schematically showing a constitution to describe an imaging section and an optical system thereof of a ninth embodiment;

FIG. 11 is a diagram-1 showing reflection characteristics with respect to an incident angle in the thin film of the first example;

FIG. 12 is a diagram-2 showing reflection characteristics with respect to an incident angle in the thin film of the first example;

FIG. 13 is a diagram-3 showing reflection characteristics with respect to an incident angle in the thin film of the first example;

FIG. 14 is a diagram-1 showing reflection characteristics of the thin film with respect to the wavelength in the thin film of the first example;

FIG. 15 is a diagram-2 showing reflection characteristics of the thin film with respect to the wavelength in the thin film of the first example;

FIG. 16 is a diagram-3 showing reflection characteristics of the thin film with respect to the wavelength in the thin film of the first example;

FIG. 17 is a diagram showing reflection characteristics with respect to an incident angle in the thin film of the second example;

FIG. 18 is a diagram-1 showing reflection characteristics of the thin film with respect to the wavelength in the thin film of the second example;

FIG. 19 is a diagram-2 showing reflection characteristics of the thin film with respect to the wavelength in the thin film of the second example;

FIG. 20 is a diagram-3 showing reflection characteristics of the thin film with respect to the wavelength in the thin film of the second example;

FIG. 21 is a diagram-1 showing reflection characteristics with respect to an incident angle in the thin film of the third example;

FIG. 22 is a diagram-2 showing reflection characteristics with respect to an incident angle in the thin film of the third example;

FIG. 23 is a diagram-3 showing reflection characteristics with respect to an incident angle in the thin film of the third example;

FIG. 24 is a diagram-1 showing reflection characteristics of the thin film with respect to the wavelength in the thin film of the third example;

FIG. 25 is a diagram-2 showing reflection characteristics of the thin film with respect to the wavelength in the thin film of the third example;

FIG. 26 is a diagram-3 showing reflection characteristics of the thin film with respect to the wavelength in the thin film of the third example;

FIG. 27 is a diagram-1 showing reflection characteristics with respect to an incident angle in the thin film of the fourth example;

FIG. 28 is a diagram-2 showing reflection characteristics with respect to an incident angle in the thin film of the fourth example;

FIG. 29 is a diagram-3 showing reflection characteristics with respect to an incident angle in the thin film of the fourth example;

FIG. 30 is a diagram-1 showing reflection characteristics of the thin film with respect to the wavelength in the thin film of the fourth example;

FIG. 31 is a diagram-2 showing reflection characteristics of the thin film with respect to the wavelength in the thin film of the fourth example;

FIG. 32 is a diagram-3 showing reflection characteristics of the thin film with respect to the wavelength in the thin film of the fourth example;

FIG. 33 is a schematic view showing a constitution of an imaging device mounted in a vehicle in the case of forward-direction imaging;

FIG. 34 is a schematic view showing the constitution of an imaging device mounted in a vehicle in the case of backward-direction imaging; and

FIGS. 35A and 35B are views showing, as an example, a normal image by the normal mode and a polarized light component reduced image by the polarized light component reduction mode.

### DESCRIPTION OF THE NUMERALS

1 (1A, 1B, and 1C): imaging device

11 (11A-11F): imaging section

12: image processing section

14: display section

16 (16A, 16B, and 16C): control section

17 (17A and 17B): mode signal generation section

111 (111A and 111B): imaging optical system

112: linear polarization section

112A and 112B: polarizer arrays

112C: linear polarization section

112C-1 and 112C-2: linear polarizer

113: imaging element

161 (161A, 161B, and 161C): mode control section

1120: polarizer unit

FL: thin film

### EMBODIMENT FOR CARRYING OUT THE INVENTION

An embodiment according to the present invention will now be described with reference to drawings. Herein, in each drawing, a constitution with the same symbols represents the same constitution. Therefore, description thereof is omitted. Further, in the present specification, for collective designation, reference symbols are shown with no subscripts, and for an individual constitution, reference symbols with subscripts are shown.

### First Embodiment

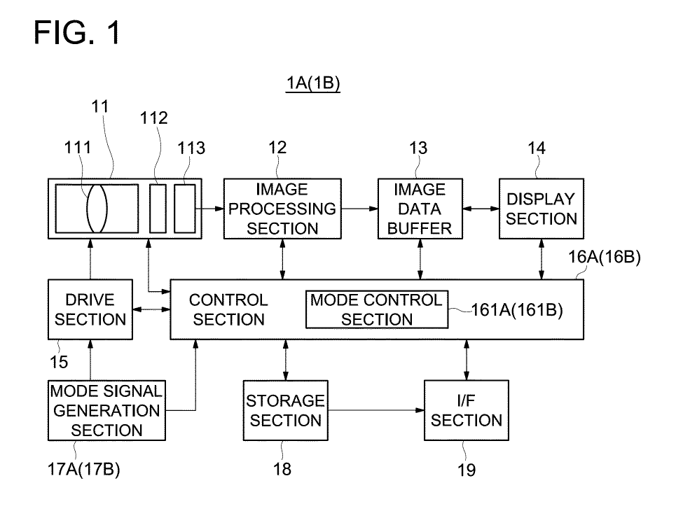

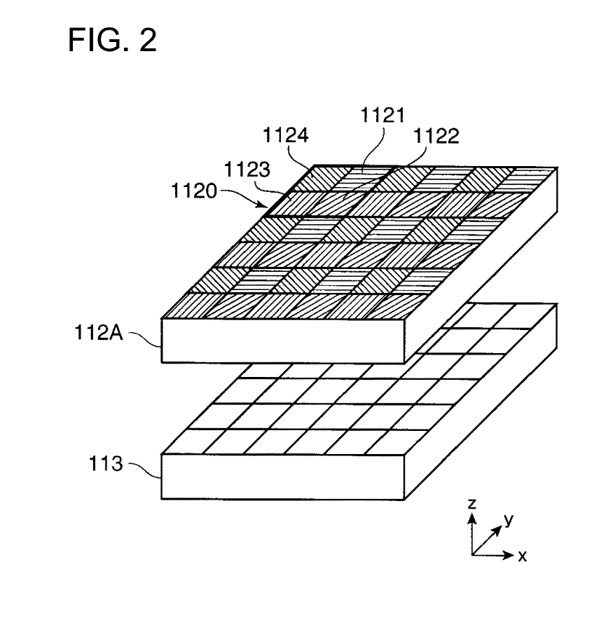

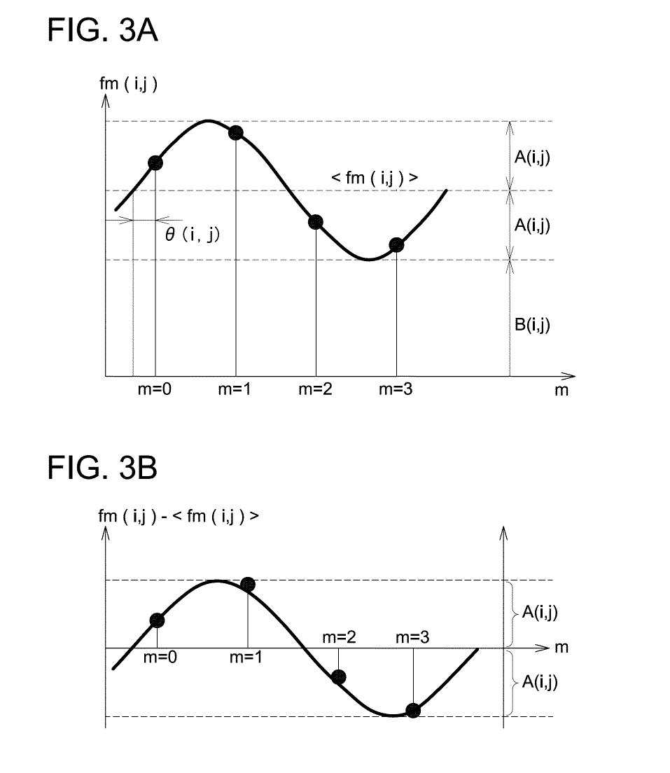

FIG. 1 is a block diagram showing a constitution of an imaging device of the embodiment. FIG. 2 is a view showing the constitution of a polarization imaging system. And, FIGS. 3A and 3B are views illustrating the intensity fm(i,j) of transmitted light received by the polarization imaging device.

In FIG. 1, an imaging device 1A is constituted by an imaging section 11, an image processing section 12, an image data buffer 13, a display section 14, a drive section 15, a control section 16A, a mode signal generation section 17A, a storage section 18, and an interface section (I/F section) 19.

The imaging device 1A includes, for example, a car-mounted camera mounted in a moving body, a surveillance camera for surveillance, and a measurement camera for measurement. Such a monitoring camera is for monitoring the surrounding environment. From the viewpoint of the ability to monitor a wider area, the viewing angle of the imaging optical system 111 is desired to be relatively large. The measurement camera is for determining an amount of a certain object based on a photographed image, determining, for example, the distance to an object ahead or the speed (relative speed or absolute speed) or acceleration of a moving body ahead. The car-mounted camera is one mounted in a moving body such as a vehicle or a robot, including, from the viewpoint of usage, a monitoring camera to monitor the exterior environment of a moving body and a measurement camera to determine, for example, the distance to an object ahead.

The imaging section 11 images pick up an image of a subject directly or alternatively through a linear polarization section 112 to reduce a polarized light component by operating the linear polarization section 112 based on a control signal output from the control section 16A, constituted by, for example, an imaging optical system 111, the linear polarization section 112, and an imaging element 113. In the linear polarization section 112, a linear polarizer is inserted in and removed from an optical path, or otherwise a liquid crystal filter is turned on and off, whereby a polarized light component is transmitted or reduced. The imaging optical system 111 is an optical system (a lens system) to focus, for example, an optical image of a subject on a predetermined focusing plane. The predetermined focusing plane is the light receiving surface of the imaging element 113 in the present embodiment. In the present embodiment, the imaging optical system 111 is also provided with an unshown lens drive device (a lens drive mechanism), to drive the lens in the optical axis direction for focusing. Herein, such a lens drive device is not necessarily constituted, and it can be to be omitted when it is used under strong vibrations are expected as car-interior use or when a simple constitution is desirable, for example. The imaging element 113 can form an optical image of a subject on the light receiving surface using the imaging optical system 111 to convert the optical image of this subject into an electrical signal. The imaging element 113 converts, for example, an optical image of a subject having been focused by the imaging optical system 111 into electrical signals (image signals) of the R, G, and B color components so as to output image signals of the individual R, G, and B, colors in the image processing section 12. The imaging element 113 is an area image sensor which is a solid-state imaging element such as a CCD image sensor or a CMOS image sensor. In the imaging element 113, an imaging operation such as readout (horizontal synchronization, vertical synchronization, and transfer) of an output signal of each pixel in the imaging element 113 is controlled by the control section 16A. Herein, the imaging element 113 is not limited to a color imaging element, and it can be a B/W imaging element.

In an imaging section 11 having the above described constitution, a light beam from a subject is focused on the light receiving surface of the imaging element 113 through the linear polarization section 112 by the imaging optical system 111 to give an optical image of the subject. In addition, when a plurality of linear polarizers are included in the linear polarization section 112, they are arranged not to be overlapped with each other on the same optical path so that the imaging element 113 can pick up an optical image of a subject.

The linear polarization section 112 is arranged at any appropriate position on the optical axis of the imaging optical system 111, and if the linear polarization section 112 is constituted by a plurality of linear polarizers, the linear polarizers are arranged to allow incident lights each to be transmitted and emitted with respect to respective transmission axes (major axes) different from each other.

As described in a ninth embodiment later, the linear polarization section 112 may be constituted by a plurality of linear polarizers each with one transmission axis (major axis) from the viewpoint of simplicity of the constitution or ease of production. However, in the present embodiment, as in fourth-eighth embodiments described later, it is constituted by a polarizer array 112A from the viewpoint of reduction of the number of components and miniaturization. For example, as shown in FIG. 2, the polarizer array 112A is constituted by one or a plurality of polarizer units 1120. The polarizer unit 1120 is divided into areas of a plurality of linear polarizers where transmission axes are different from each other, for example areas 1121-1124 in the example shown in FIG. 2, being an optical element to allow the non-polarized light component of an incident light in each of the areas 1121-1124 among the incident lights to be transmitted, as well as allowing the polarized light components of the incident lights differing in polarization direction to be transmitted by the areas 1121-1124. The linear polarizer of each of the areas 1121-1124 has a multi-layer structured body in which at least 2 types of transparent materials are alternately laminated in the z direction, for example, so that in the orthogonal coordinate system xyz, a linear polarizer is formed on a transparent substrate parallel to the xy plane. The surface of the linear polarizer of each of the areas 1121-1124 in the x-y plane is formed into a concavo-convex shape, and this concavo-convex shape is periodically repeatedly formed, for example, by self-cloning in one direction-. For example, the linear polarizer of the area 1121 is designated as a reference of the transmission axis (major axis) and the groove direction is 0 degree with respect to the x axis. In the linear polarizer of the area 1122, the groove direction is 45 degrees with respect to the x axis. In the linear polarizer of the area 1123, the groove direction is 90 degrees with respect to the x axis. And, in the linear polarizer of the area 1124, the groove direction is 135 degrees with respect to the x axis.

The number of the linear polarizers is appropriately determined. Also, the directions of the transmission axes are appropriately determined, as well as their arrangement. Herein, it is desirable to arrange the linear polarizer so that the transmission axes are equiangularly arranged having angles of a value obtained by dividing 180 degrees by the number of different transmission axis directions of the linear polarizers, for example, as follows: when the transmission axes of the linear polarizers are in 2 directions, these transmission axes are allowed to intersect at about 90 degrees; when the transmission axes of the linear polarizers are in 3 directions, the transmission axes each are allowed to intersect at about 60 degrees (about 60 degrees and about 120 degrees); and when the transmission axes of the linear polarizers are in 4 directions, as in the present embodiment, the transmission axes each are allowed to intersect at about 45 degrees (about 45 degrees, about 90 degrees, about 135 degrees, and about 180 degrees). Thus, regardless of the polarization state of stray light, the transmission axis of the linear polarizer can be arranged at about 90 degrees to the polarization direction of the stay light, whereby stray light intensity can effectively be reduced.

Further, when the polarizer array 112A is constituted by a plurality of polarizer units 1120, a plurality of the polarizer units 1120 are arranged so that each incident plane is in-plane and each emission plane is in-plane.

The linear polarization section 112 and the imaging element 113 may individually be arranged as described in a fifth embodiment later, but in the present embodiment, they are constituted as a polarization imaging system. In FIG. 2, for convenience of description, the polarizer array 112A of the linear polarization section 112 and the imaging element 113 are separately shown. Herein, the polarizer array 12A is arranged so as to be stacked on the imaging element 113 constituting an array imaging element provided with a plurality of pixels arranged in a two-dimensional, array-shaped manner In this manner, employment of such a polarization imaging system makes it possible to easily attach the linear polarization section 112 and the imaging element 113 to the imaging section 11.

The image processing section 12 forms an image corresponding to an optical image of a subject based on the output of the imaging section 11 in response to a control signal output from the control section 16A. Image data of the thus-formed image is output to the image data buffer 13. When there is provided another optical pass which does not reduce the polarized light component, the linear polarizer does not need to be driven.

In general, light from a subject contains a polarized light component and a non-polarized light component. Herein, similarly to Patent Document 1, the polarized light component refers to a component whose intensity is varied with the rotational angle of a polarizer when light is passed through the polarizer, meaning so-called linear polarization or elliptical polarization. The non-polarized light component refers to a component whose intensity is not varied with the rotational angle of the polarizer when light is passed through the polarizer as in Patent document 1, meaning so-called non-polarization or circular polarization.

The polarized light component reduction mode refers to a mode in which a non-polarized light component in a light beam having reached the imaging element of an imaging section is separated (extracted), whereby an image is formed of this non-polarized light component. The polarized light component reduced image refers to an image formed of a non-polarized light component in which the non-polarized light component in a light beam having reached the imaging element of the imaging section is separated (extracted). Further, the normal mode refers to a mode in which an image is formed from a light beam, containing a polarized light component, having reached the imaging element of the imaging section without separating (extracting) the non-polarized light component. And, the normal image refers to an image formed from a light beam, containing a polarized light component, having reached the imaging element of the imaging section without separating (extracting) the non-polarized light component.

The image processing section 12 separates an optical image of a subject into a polarized light component and a non-polarized light component, and extracts the non-polarized light component in the polarized light component reduction mode to form a polarized light component reduced image based on this non-polarized light component; and extracts no non-polarized light component in the normal mode to form a normal image from a light beam having reached the imaging element 113 of the imaging section 11. Herein, the normal image includes an image formed of a polarized light component and a non-polarized light component. The image processing section 12 may form a normal image from the polarized light component and the non-polarized light component. Stray light usually contains a polarized light component. Therefore, when a polarized light component reduced image is formed, an image, in which the stray light is reduced or eliminated, can be obtained.

To be more specific, the image processing section 12 forms a polarized light component reduced image or a normal image depending on the mode by using the method disclosed, for example, in Unexamined Japanese Patent Application Publication No. 2007-086720 described above.

Initially, the polarizer unit 1120 shown in FIG. 2 and a corresponding part of the imaging element 113 (referred to as an imaging element array) are expressed in coordinate (i,j). Then, a transmitted light intensity obtained from the polarizer unit 1120 of coordinate (i,j) is denoted fm(i,j). In this case, the polarizer unit 1120 contains data with respect to 4 directions of the areas 1121-1124 each. The transmitted light intensity fm(i,j) of the polarizer unit 1120 is a sum of the intensity A(i,j) of polarized light components each differing in the areas 1120-1124 and the intensity B(i,j) of a non-polarized light component uniform in the entire area, being represented as following Expression (A). Herein, the maximum intensity (vibration amplitude) of the polarized light component is 2A(i,j) and the amplitude is A(i,j).

fm(i,j)=A(i,j)×[1+cos(2×Θm+2×Θ(i,j))]+B(i,j) (A)

wherein m represents a number assigned to each area 1121-1124; i and j each represents a coordinate value of the polarizer unit 1120 in the polarizer array 112A; Θm represents an angle of the transmission axis in each area 1121-1124 (the transmission axis of the area 1121 is designated as 0 degree for the reference); and Θ(i,j) represents the angle difference between the polarization direction of a polarized light component entering the polarizer unit 1120 and the transmission axis in the reference area.

The intensity A(i,j) of a polarized light component, the intensity B(i,j) of a non-polarized light component, and the angle difference Θ(i,j) are periodically varied to a larger extent than the size of the polarizer unit 1120, resulting in being considered uniform in one polarizer unit 1120. Therefore, as shown in FIG. 3A, when the horizontal axis is designated as in and the vertical axis is designated as fm(i,j), the fm(i,j) results in intensity distribution in which the intensity A(i,j) of polarized light components differing in transmission intensity based on the angle of the transmission axis in each area 1121-1124 is added to the intensity B(i,j) of a certain quantity of a non-polarized light component.

Thus, in the image processing section 12, fitting of above Expression (A) is carried out to the intensity fm(i,j) of transmitted light having been transmitted through each area with respect to the angle of the transmission axis of each area constituting the polarizer unit 1120, whereby the transmitted light intensity fm(i,j) can be separated into the intensity A(i,j) of the polarized light component and the intensity B(i,j) of the non-polarized light component. Then, the image processing section 12 reconfigures each of the thus-separated components A(i,j) and B(i,j) based on the mode, whereby an image can be formed based on the mode.

Herein, as is obvious from FIG. 3A, the average value <fm(i,j)> of the transmitted light intensities fm(i,j) is the sum (=A(i,j)+B(i,j)) of A(i,j)+B(i,j). Therefore, Expression (A) can be transformed to Expression (B), and then Expression (B) represents intensity distribution in FIG. 3B.

fm(i,j)−<fm(i,j)>=A(i,j)×cos(2×Θm+2×Θ(i,j)) (B)

Therefore, in the image processing section 12, when fitting of above Expression (B) is carried out to an intensity obtained by subtracting the average value <fm(i,j)> of transmitted light intensities from the intensity fm(i,j) of transmitted light having been transmitted through each area with respect to the angle of the transmission axis of each area constituting the polarizer unit 1120, the intensity A(i,j) of a polarized light component may be obtained, and then based on the intensity A(i,j) of this polarized light component, the intensity B(i,j) of a non-polarized light component may be obtained.

Further, the image processing section 12, as appropriate, carries out amplification processing and digital conversion processing for an analog output signal from the imaging section 11, as well as carrying out well-known image processing such as appropriate black level determination, γ correction, white balance adjustment (WB adjustment), outline correction, color nonuniformity correction, and distortion correction for the entire image.

The image data buffer 13 is a memory for temporally memorizing image data in response to a control signal output from the control section 16A and also for serving as a work area for processing, by the image processing section 12, with respect to the image data, being constituted by RAM (Random Access Memory) which is a volatile memory element.

The display section 14 is a display device to display an image formed by the image processing section 12, for example, a normal image or a polarized light component reduced image, and is, for example, a liquid crystal display device (LCD), an organic EL display device, or a plasma display device.

The drive section 15 is a circuit to allow the above unshown lens drive device to operate to perform focusing of the imaging optical system 111 in the imaging section 11, in response to a control signal output from the control section 16A. The storage section 18 is a memory circuit to store image data generated by an imaging operation with respect to a subject, and is constituted, for example, by EEPROM (Electrically Erasable Programmable Read Only Memory) or RAM which is a rewritable, nonvolatile memory element. The IT section 19 is an interface to carry out transmission and reception of image data for external devices, and is an interface compatible with a standard such as USB and IEEE 1394.

The mode signal generation section 17A generates a mode signal to determine the mode of an image formed in the image processing section 12. The mode includes at least a polarized light component reduction mode to form an image of a non-polarized light component by extracting such a non-polarized light component in a light beam having reached the imaging element 113 of the imaging section 11; and a normal mode to form an image of a light beam, containing a polarized light component, having reached the imaging element 113 of the imaging section 11 without extracting a non-polarized light component.

The mode signal generation section 17A is an optical sensor, for example, to detect external light quantity and outputs the detected external light quantity to the control section 16A as a mode signal in response to a control signal output from the control section 16A. As such an optical sensor, a photodiode such as a PN photodiode, a PIN photodiode, an avalanche photodiode, or a Schottky photodiode is employed.

The control section 16A is constituted by, for example, a microprocessor, a memory element, and peripheral circuits thereof, and controls the operation of each of the imaging section 11, the image processing section 12, the image data buffer 13, the display section 14, the drive section 15, the mode signal generation section 17, the storage section 18, and the I/F section 19, based on the functions thereof The control section 16A is functionally provided with a mode control section 161A.

The mode control section 161A causes the image processing section 12 to form a normal image when the mode signal of the mode signal generation section 17A having been input from the mode signal generation section 17A to the control section 16A is judged to indicate the normal mode; and causes the image processing section 12 to form a polarized light component reduced image when a mode signal of the mode signal generation section 17A is judged to indicate the polarized light component reduction mode. In the judgment of this mode switching, since the mode control section 161A is constituted in such a manner that in the present embodiment, the mode signal generation section 161A is provided with an optical sensor, for example, when an output value of the mode signal generation section 161A (the optical sensor) is at least a specific threshold value having been previously set, the judgment that the normal mode is indicated is made; and when the output value of the mode signal generation section 161A (the optical sensor) is less than the specific threshold value, the judgment that the polarized light component reduction mode is indicated is made. In this manner, the mode control section 161A judges the mode of an image to be formed based on the mode signal of the mode signal generation section 161A, and then causes the image processing section 12 to operate in the normal mode or in the polarized light component reduction mode based on the judged result.

In the imaging device 1A with the above described constitution, initially, the control section 16A controls the imaging section 11 to carry out an imaging operation and also allows the unshown lens drive device of the imaging section 11 to operate with the drive section 15 for focusing. Thus, a focused optical image of the subject is periodically repeatedly focused on the light receiving surface of the imaging element 113 of the imaging section 11, followed by conversion into image signals of the R, G, and B color components to be output to the image processing section 12.

Further, the control section 16A receives a mode signal from the mode signal generation section 17A to judge the mode based on this mode signal.

From this judgment result, when the mode is the normal mode, the mode control section 161A allows the image processing section 12 to operate in the normal mode and then the image processing section 12 forms a normal image from the output of the imaging section 11, for example, by the above method. Then, image data of this normal image is stored in the image data buffer 13. The control section 16A allows the image data having been stored in the image data buffer 13 to be displayed in the display section 14. Thus, the normal image is displayed in the display section 14.

In contrast, when the mode is judged to be the polarized light component reduction mode, the mode control section 161A allows the image processing section 12 to operate in the polarized light component reduction mode, and then the image processing section 12 forms a polarized light component reduced image from the output of the imaging section 11, for example, by the above method. Then, image data of this polarized light component reduced image is stored in the image data buffer 13. The control section 16A allows the image data having been stored in the image data buffer 13 to be displayed in the display section 14. Thus, the polarized light component reduced image is displayed in the display section 14.

Such an operation makes it possible that the imaging device 1A of the first embodiment automatically switches whether to reduce stray light or not, depending on the situation.

In the case of occurrence of stray light, even when the intensity of the stray light is the same, the stray light is more noticeable when the environment is dark than when the environment is bright. The reason is that when the environment is dark, the exposure time is relatively long, compared with when the environment is bright. In the imaging device 1A of the first embodiment, an optical sensor as the mode signal generation section 17 is used to detect external light in the exterior environment. Thus, when the environment is dark, the mode is switched to the polarized light component reduction mode to obtain an image in which stray light having a polarized light component is reduced or eliminated (a polarized light component reduced image). On the other hand., when the environment is bright, the mode is switched to the normal mode to obtain a more natural image (a normal image). In this manner, the imaging device 1A of the first embodiment can automatically obtain an appropriate image depending on whether the environment is bright or dark.

Next, another embodiment will now be described.

### Second Embodiment

In the first embodiment, the mode signal generation section 17A was constituted by an optical sensor. In a second embodiment, a mode signal generation section 17B is constituted by a clock section to tell time. Therefore, the imaging device 1B of the second embodiment is the same as the imaging device 1A of the first embodiment except that a mode signal generation section 17B and the mode control section 161B of a control section 16B are provided, instead of the mode signal generation section 17A and the mode control section 161A of the control section 16A in the imaging device 1A of the first embodiment, respectively. Therefore, description is omitted except for the difference.

The mode signal generation section 17B constituted by a clock section outputs a current time to the control section 16B as a mode signal in response to a control signal output from the control section 16B. Herein, the mode signal generation section 17B of the clock section may functionally be constituted in the control section 16B in such a manner that the clock section is configured with software.

The mode control section 161B of the control section 16B judges it to be the normal mode when an output value (a current time) of the clock section falls within a predetermined time zone having been previously set; and judges it to be the polarized light component reduction mode when the output value (a current time) of the clock section falls outside the predetermined time zone having been previously set. The predetermined time zone is appropriately set based on the extent of occurrence of stray light. For example, a bright time zone such as a daylight time zone is employed.

Also in this constitution, the imaging device 1B of the second embodiment can automatically switch whether to reduce stray light or not, depending on the situation.

The imaging device 1B of the second embodiment can assume the extent of external light of the exterior environment using the clock section. Thus, when the environment is dark, the mode is switched to the polarized light component reduction mode to obtain an image in which stray light having a polarized light component is reduced or eliminated (a polarized light component reduced image). In contrast, when the environment is bright, the mode is switched to the normal mode to obtain a more natural image (a normal image).

Another embodiment will now be described.

### Third Embodiment

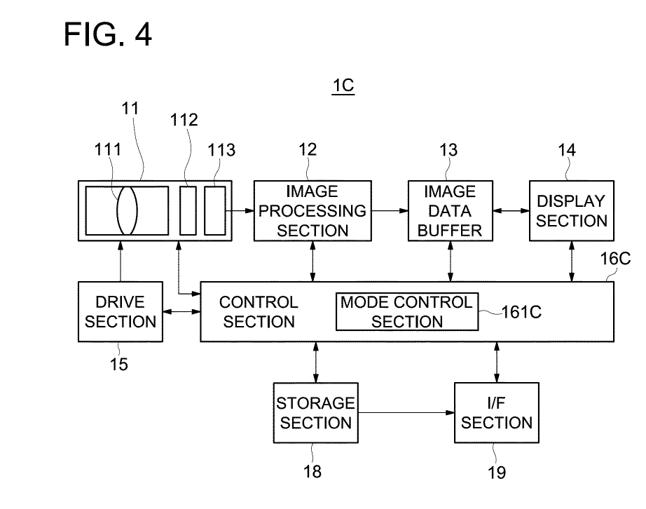

FIG. 4 is a block diagram showing the constitution of an imaging device in a third embodiment. In the first embodiment, the mode signal generation section 17A was constituted by an optical sensor. However, in the third embodiment, the imaging element 113 of an imaging section 11 is also used as a mode signal generation section. Thus, as shown in FIG. 4, the imaging device 1C of the third embodiment is constituted by an imaging section 11 functioning also as the mode signal generation section, an image processing section 12, an image data buffer 13, a display section 14, a drive section 15, a control section 16C, a storage section 18, and an If section 19. A separate constituent member, as shown in the imaging devices 1A and 1B of the first and second embodiments, functioning as the mode signal generation section is not provided. The imaging section 11, the image processing section 12, the image data buffer 13, the display section 14, the drive section 15, the storage section 18, and the I/F section 19 are the same as in the first embodiment except that the imaging element 113 of the imaging section 11 functions as the mode signal generation section. Therefore, description thereof is omitted.

The control section 16C is functionally the same as the control section 16A of the first embodiment except that a mode control section 161C is provided instead of the mode control section 161A. The mode control section 161C judges it to be the normal mode when an output value of the imaging element 113 is at least a specific threshold value having been previously set; and judges it to be the polarized light component reduction mode when such an output value of the imaging element 113 is less than the specific threshold value. As the output value of the imaging element 113, a luminance average value in all the pixels (an entire luminance average value) is employed to evaluate, for example, the brightness of the exterior environment. Further, for example, to judge whether or not a spot light source exists in the exterior environment, a luminance average value in a area with a predetermined size set in the surrounding of a pixel of the maximum luminance value (a local luminance average value) is employed. Further, for example, the above mentioned entire luminance average value and local luminance average value are employed.

Also in this constitution, the imaging device 1C of the third embodiment can automatically switch whether to reduce stray light or not, depending on the situation.

In the imaging device 1C of the third embodiment, the mode signal generation section is also used as the imaging element 113 of the imaging section 11. Thus, neither an optical sensor to detect external light quantity nor a clock section to measure the clock time separately needs to be provided, whereby the constitution of the imaging device 1C results in a general configuration. Therefore, with an appropriate timing, an image, in which stray light having a polarized light component is reduced or eliminated, can be obtained at reduced cost.

Further, other than the case of the brightness of the exterior environment, also when an intense spot light source enters the imaging device 113, stray light becomes noticeable in some cases. The main reason is that when a light beam having a larger intensity than expected enters the imaging device 1C, the intensity of stray light cannot be reduced using an anti-reflection countermeasure provided for the imaging device 1C, whereby reflection thereof is repeated within the imaging device 1C and then the stray light eventually reaches the imaging element 113. Even in such a case, in the imaging device 1C of the third embodiment, depending on information obtained by the imaging element 113, when the environment is dark or a spot light source of a relatively large intensity (a spot light source of an intensity of at least a predetermined threshold value) exists, the mode is switched to the polarized light component reduction mode. Thus, an image in which stray light having a polarized light component is reduced or eliminated (a polarized light component reduced image) can be obtained. In contrast, when the environment is bright or a spot light source of a relatively large intensity exists, the mode is switched to the normal mode, whereby a more natural image (a normal image) can be obtained.

Next, more specific constitutions of the imaging sections 11 in the first-third embodiments will now be described as fourth-ninth embodiments.

### Fourth Embodiment

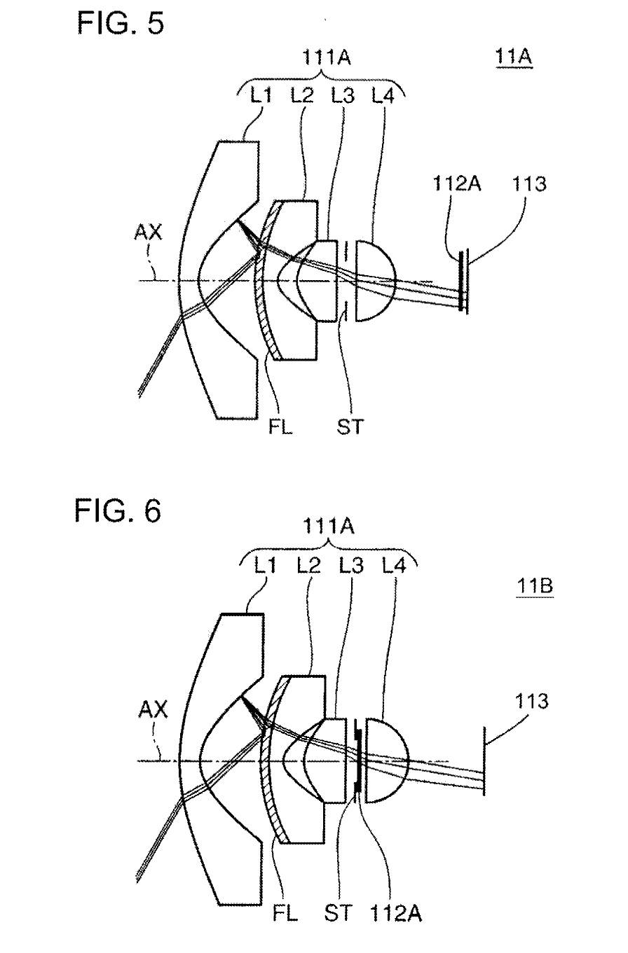

FIG. 5 is a sectional view of a lens schematically showing a constitution to describe an imaging section and an optical system thereof of a fourth embodiment. In FIG. 5, the imaging section 11A is provided with an imaging optical system 111A, a polarizer array 112A as the linear polarization section, and an imaging element 113. The imaging optical system 111A makes it possible that through the polarizer array 112A, for example, an optical image of a subject is formed on the light receiving surface of the imaging element 113.

The imaging optical system 111A forms an optical image of the subject on the light receiving surface (the image plane) of the imaging element 113. Herein, in the drawing, the left side is designed as an object side and the right side is designated as an image side, which is common for the drawing of every imaging optical system to be shown below. The imaging optical system 111A is provided with, for example, a first lens L1 which is a negative lens convex to the object side, a second lens L2 which is a negative lens convex to the object side, a third lens L3 which is a positive lens convex to the object side, and a fourth lens L4 which is a positive lens convex to the image side in order from the object side to the image side. The imaging optical system 111A of the present embodiment is constituted by four lenses. Herein, the imaging optical system 111A can employ any appropriate constitution with an appropriate number of lenses if an optical image is focused on a specific focusing surface, which is the same as in the fifth-ninth embodiments.

Herein, in the present specification, the expression of the surface shape is one based on paraxial curvature. When the expression of “convex,” “concave,” or “meniscus” is used, any of these represents the lens shape in the vicinity of the optical axis (near the center of the lens) (namely, an expression based on the paraxial curvature).

Further, the imaging optical system 111A is provided with a thin film FL on the upstream side than the polarizer array 112A in the traveling direction of light in the imaging optical system 111A and an aperture stop ST between the third lens L3 and the fourth lens L4. The thin film FL is an anti-reflection film in which p-polarized light and s-polarized light differ in reflectance. The thin film FL is constituted, for example, of a dielectric multi-layered film, being formed using a well-known production method such as an ion-plating method or a sputtering method. In the present embodiment, the thin film FL is formed on the optical surface (the lens surface) on the object side in the second lens L2. The aperture stop ST is a member to determine which light beam is the light beam having largest angle with respect to the optical axis AX in light beams which are emitted from a spot on the optical axis AX on the object plane and then reach a spot on the optical axis AX on the image plane.

The polarizer array 112A is arranged in an appropriate position on the optical axis AX of the imaging optical section 111A and constituted by a plurality of linear polarizers to allow incident lights each to be transmitted and emitted with respect to a plurality of transmission axes (major axes) differing from each other. In the fourth embodiment, the polarizer array 112A is arranged on the image side of the imaging optical system 111A, more specifically at the front of the imaging element 113.

The imaging element 113, on which an optical image of a subject on the light receiving surface can be formed by the imaging optical system 111A, is for converting this optical image of the subject into an electrical signal.

In the imaging section 11A of the above described constitution, a subject optical image on the object side is led to the light receiving surface of the imaging element 113 through the imaging optical system 111A. Then, the subject optical image is imaged by the imaging element 113. Subsequently, an image signal is output from the imaging element 113 of the imaging section 11A to an unshown image processing section 12.

Generally, stray light (ghost/flare) is reflected at least once in the optical system by the time reaching the imaging element. The imaging section 11A and the imaging device 1 (1A, 1B, or 1C) of this constitution each are provided with a thin film FL on the optical surface of the imaging optical system 111A, whereby reflectance on the optical surface can be reduced. And thereby, the intensity of stray light can be reduced by the time reaching the imaging element 113. Further, such a thin film FL is provided, whereby reflection loss can be reduced. In addition, transmittance is enhanced accordingly, whereby a brighter original subject optical image can be obtained. Further, with the intensity of light emitted from the light source, the intensity of stray light is increased. Therefore, when the intensity of light itself emitted from the light source is large, an adverse effect resulting from stray light may be frequently noticeable in an imaged image. Even in such a case, in the imaging section 11A and the imaging device 1 of the above constitution, stray light intensity is reduced by the thin film FL and in addition, at least one polarizer array 112A is provided in the optical system, whereby stray light having polarized light at right angles to the main axis of each linear polarizer of the polarizer array 112A can be reduced. In addition, in the imaging section 11A and the imaging device 1 of the above constitution, with regard to the thin film FL, p-polarized light and s-polarized light differ in reflectance, whereby p-polarized light and s-polarized light become different in stray light intensity. And thereby, each linear polarizer of the polarizer array 112A can effectively reduce stray light. In the imaging section 11A and the imaging device 1 constituted in such a manner, the thin film FL and each linear polarizer of the polarizer array 112A with the above characteristics work together, whereby stray light is reduced and then information on an original subject optical image can be obtained more appropriately.

In this manner, in the fourth embodiment, similarly to the fifth-ninth embodiments to be described later, stray light can be reduced also in the imaging section 11A, whereby the stray light can effectively be reduced or eliminated in combination with the processing of an image processing section 12 in the subsequent step.

Further, in the imaging section 11A and the imaging device 1 of the above constitution, a thin film FL is formed on the optical surface of the object side in the second lens L2. A light beam resulting in stray light enters the thin film FL obliquely to a relatively large extent. Therefore, the p-polarized light and the s-polarized light are largely different in reflectance of the provided thin film FL, whereby the stray light can effectively be reduced.

Another embodiment will now be described.

### Fifth Embodiment

FIG. 6 is a sectional view of a lens schematically showing a constitution to describe an imaging section and an optical system thereof of a fifth embodiment. In the imaging section 11A of the fourth embodiment, the polarizer array 112A as the linear polarization section 112 was arranged on the image side of the imaging optical system 111A. As shown in FIG. 6, in an imaging section 11B of the fifth embodiment, a linear polarization section 112 is arranged in the imaging optical system 111A, more specifically between the third lens 3L and the fourth lens L4, and still more specifically between the aperture stop ST and the fourth lens L4 (on the image side of the aperture stop ST). The linear polarization section 112 of this embodiment has only one transmission axis. The imaging section 11B of the fifth embodiment is the same as the imaging section 11A of the fourth embodiment except that the arrangement position of the linear polarization section 112 differs. Therefore, description thereof is omitted.

Also with the above described constitution, in the imaging section 11B and the imaging device 1 of the fifth embodiment, stray light can effectively be reduced in the same manner as in the imaging section 11A and the imaging device 1 of the fourth embodiment, whereby information on an original subject optical image can be obtained more appropriately.

In particular, when the linear polarization section 112 is arranged in the vicinity of the aperture stop ST, the size of the linear polarization section 112 can be reduced as compared with the case of arrangement in front of the imaging element 113, whereby the cost can be reduced.

Although in the fourth embodiment, the linear polarization section 112 is arranged on the image side of the imaging optical system 111A, in the fifth embodiment, the linear polarization section 112 is arranged on the image side of the aperture stop ST. However, arrangement is not limited to these arrangements. Basically, the linear polarization section 112 needs only to be arranged on the downstream side from the thin film FL and also on the upstream side from the imaging element 113 in the traveling direction of light, namely between the thin film FL and the imaging element 113.

Another embodiment will now be described.

### Sixth Embodiment

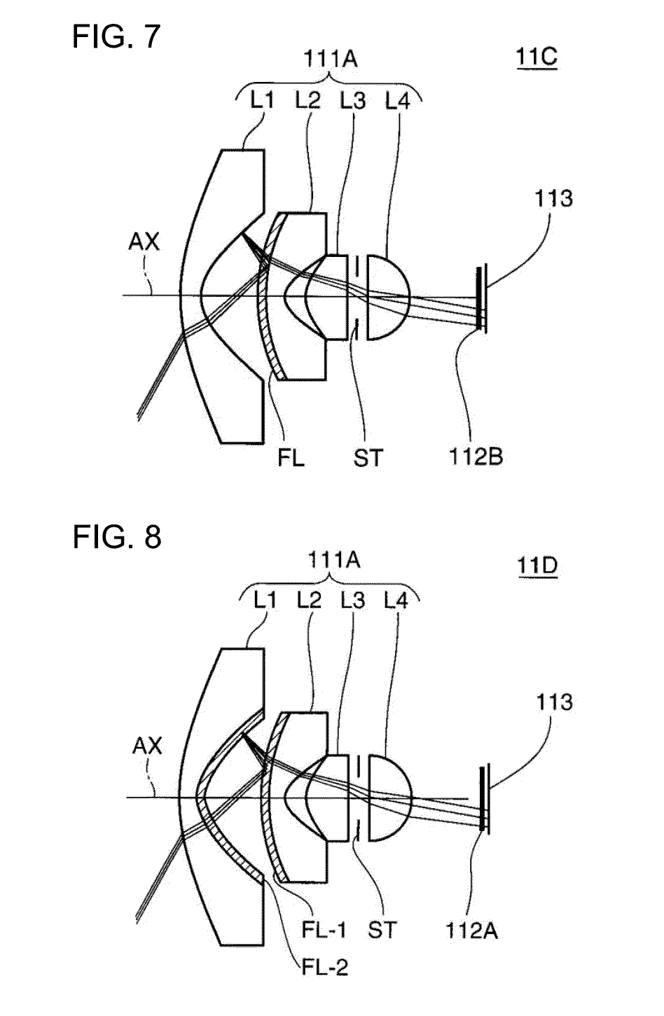

FIG. 7 is a sectional view of a lens schematically showing a constitution to describe an imaging section and an optical system thereof of a sixth embodiment. In an imaging section 11C of the sixth embodiment, a polarizer array 112B is constituted by a photonic crystal as shown in FIG. 7. The imaging section 11C of the sixth embodiment is the same as the imaging section 11A of the fourth embodiment except that instead of the polarizer array 112A, the polarizer array 112B is used in which a plurality of linear polarizers are constituted by a photonic crystal. Therefore, description thereof is omitted.

A photonic crystal represents a structure body in which materials differing in reflective index are periodically aligned. A two-dimensionally or three-dimensionally periodic structure body is specifically referred to as a photonic crystal. The photonic crystal differs from a material crystal and is an artificial optical element internally having periodic refractive index distribution usually equal to or smaller than the wavelength of light The photonic crystal has properties in which in the same manner as in the phenomenon where in a semiconductor, an electron (an electronic wave) is subjected to Bragg reflection by a periodical potential of the nucleus to form a band gap, a light wave is subjected to Bragg reflection by periodic refractive index distribution to form a band gap with respect to light (a photonic band gap). In the photonic band gap, the existence of light itself is impossible, whereby the photonic crystal can control light and constitute a linear polarizer.

In the polarizer array 112B, the linear polarizer formed of a photonic crystal is constituted by a two-dimensional optical multi-layered film substantially differing in refractive index in the axis directions.

In the imaging section 11C and the imaging device 1 of the sixth embodiment, the polarizer array 112B is constituted by a photonic crystal, whereby a plurality of linear polarizers having the main axis in different directions are easily arranged on the surface of the imaging element 113. And thereby, stray light is effectively reduced, whereby original image information can be obtained more appropriately.

Another embodiment will now be described.

### Seventh Embodiment

FIG. 8 is a sectional view of a lens schematically showing a constitution to describe an imaging section and an optical system thereof of a seventh embodiment. In an imaging section 11D of the seventh embodiment, as sown in FIG, 8, a thin film FL-1 formed on the optical surface of the object side in the second lens L2 is provided and also a thin film FL-2 formed on the optical surface of the image side in the first lens L1 is provided. The thin film FL-1 and the thin film FL-2 are anti-reflection films having the difference in reflectance between p-polarized light and s-polarized light. The thin film FL-1 and the thin film FL-2 may be the same or differ. When both are the same, even different lenses can be vapor-deposited at the same time, resulting in being applicable to mass production and in reduced cost. When the both differ, in view of the incident angle of stray light with respect to each lens, optimal film designing can be conducted and stray light can further be reduced.

The imaging section 11D of the seventh embodiment is the same as the imaging section 11A of the fourth embodiment except that the number of thin films FL is large. Therefore, description thereof is omitted.

In the imaging section 11D and the imaging device 1 of the seventh embodiment, a plurality of thin films FL are provided in the imaging optical system 111A, whereby stray light can be reduced more effectively and information of a original subject optical image can be obtained far more appropriately.

Although in the fourth-sixth embodiments, a single thin film FL is formed on the optical surface of the object side in the second lens L2, in the seventh embodiment, 2 thin films FL-1 and FL-2 are each formed on the optical surface of the object side in the second lens L2 and on the optical surface of the image side in the first lens L-1. However, arrangement is not limited to this arrangement. Basically, in the imaging optical system 111A, at least one thin film FL needs only to be positioned on the upstream side from the linear polarization section 112 (112A or 112B) in the traveling direction of light.

Another embodiment will now be described.

### Eighth Embodiment

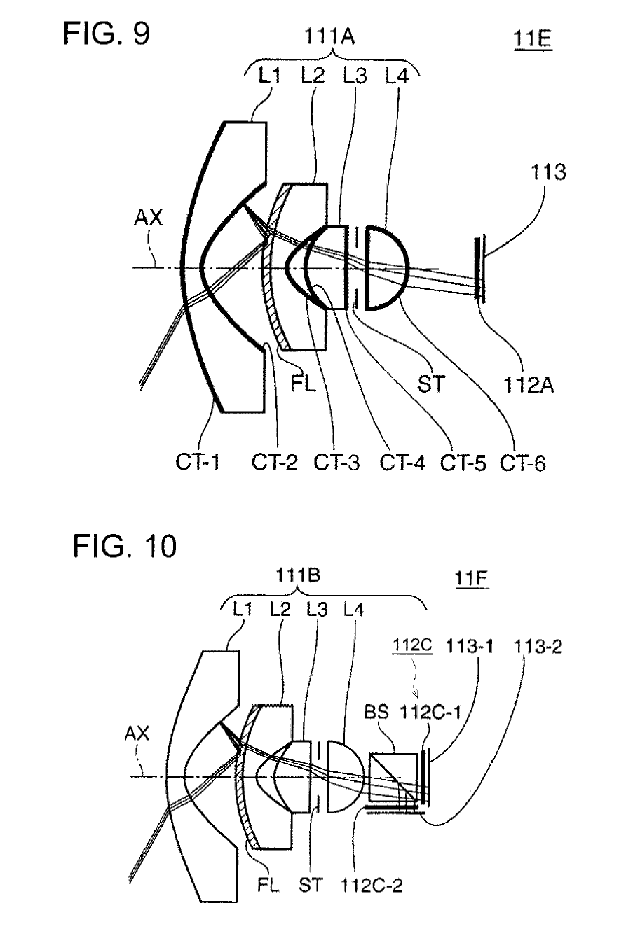

FIG. 9 is a sectional view of a lens schematically showing a constitution to describe an imaging section and an optical system thereof of an eighth embodiment. As shown in FIG. 9, an imaging section HE of the eighth embodiment is provided with common anti-reflection films CT (CT-1-CT-6) formed on each optical surface in the imaging optical system 111A except the optical surface of the object side in the second lens L2 where the above thin film FL (FL-1) is formed.

The imaging section 11E of the eighth embodiment is the same as the imaging section 11A of the fourth embodiment except that the common anti-reflection films CT (CT-1-CT-6) are formed on each optical surface in the imaging optical system 111A except the optical surface of the object side in the second lens L2 where the thin film FL (FL-1) is formed. Therefore, description thereof is omitted.

In the imaging optical system 111A of the constitution shown in FIG. 9, the optical surface of the object side in the second lens L2 is a reflection surface of stray light of large intensity reaching the imaging element 113. Such “stray light of large intensity” is visually easily noticeable as described above. Further, the “common anti-reflection film” is a film in which the reflectance of each polarized light are not ore different than in the thin film FL, but which film reduces a stray light component such as flare other than stray light of large intensity. Herein, in the common anti-reflection film CT, reflectance difference may exist between two polarized lights, however, the reflectance difference between two polarized lights is smaller than in the thin film FL.

Therefore, in the thin film FL, the difference between p-polarized light and s-polarized light in reflectance is preferably relatively large. Further, in the common anti-reflection film CT, the difference between p-polarized light and s-polarized light in reflectance is preferably relatively small to the extent that a stray light component such as flare other than stray light of large intensity is reduced.

In the imaging section 11E and imaging device 1 of the eighth embodiment, the thin film FL is provided on the optical surface of the object side in the second lens L2 which is a reflection surface of stray light of large intensity reaching the imaging element 113, whereby the intensity of stray light reaching the imaging element 113 is more effectively reduced. And thereby, information on an original subject optical image can be obtained more appropriately. Further, common anti-reflection films CT-1-CT-6 are provided on the other optical surfaces in the imaging optical system 111A, whereby the intensity of stray light reaching the imaging element 113 is more effectively reduced. Thus, information on an original subject optical image can be obtained more appropriately.

Another embodiment will now be described.

### Ninth Embodiment

FIG. 10 is a sectional view of a lens schematically showing a constitution to describe an imaging section and an optical system thereof of a ninth embodiment. As shown in FIG. 10, an imaging section 11F of the ninth embodiment is provided, as linear polarization sections 1120, with 2 linear polarizers 112C-1 and 112C-2 arranged so as for the main axes thereof each to be faced in different directions.

To be more specific, the imaging section 11F of the ninth embodiment is provided with an imaging optical system 111B, and two imaging elements 113-1 and 113-2 to convert an optical image into an electrical signal. The imaging optical system 111B can form an optical image of, for example, a subject on each light receiving surface of the imaging element 113-1 and the imaging element 113-2.

The imaging optical system 111B forms an optical image on each light receiving surface (each image plane) of the imaging element 113-1 and the imaging element 113-2, and is constituted by, for example, a first lens L1, a second lens L2 on the object side of which a thin film FL is formed, a third lens L3, an aperture stop ST, and a fourth lens L4, as well as a beam splitter BS on the image side of the fourth lens in the order from the object side to the image side.

The first-fourth lenses L1-L4, the thin film FL, and the aperture stop ST each are the same as the first-fourth lenses L1-L4, the thin film FL, and the aperture stop ST of the fourth embodiment.

The beam splitter BS is an optical element to separate incident light into two for emission. In the present embodiment, as shown in FIG. 10, the beam splitter BS is provided with 2 deviation prisms to deviate the traveling direction of a light beam at 90 degrees. A constitution is made by joining these two deviation prisms such that these deviation planes face each other. In the joining surface area, a half mirror (a semitransparent mirror) is formed.

The linear polarizers 112C-1 and 112C-2, as the linear polarization section, each are arranged in any appropriate position on the light axis AX of the imaging optical system 111B, being an optical element to convert incident light into linearly polarized light for emission, and being constituted with a single transmission axis. The linear polarization section 112C is constituted, for example, of a polymer-made polarization film. In the present embodiment, one linear polarizer 112C-1 is arranged so that one light beam having been separated by the beam splitter BS enters, and the other linear polarizer 112C-2 is arranged so as for the other light beam having been separated by the beam splitter BS enters. When an image of the normal mode is imaged, the linear polarization section 112C is removed from the optical path. In the present embodiment, as described above, the beam splitter BS is constituted by two deviation prisms of a cross-section right angle isosceles triangle which are joined at the deviation surface thereof Thus, the cross-section of the beam splitter BS is square. One linear polarizer 112C-1 is arranged such that the incident surface thereof is parallel to a first emission surface facing the incident surface of the beam splitter BS, and the other linear polarizer 112C-2 is arranged such that the incident surface thereof is parallel to a second emission surface perpendicular to the incident surface of the beam splitter BS. With regard to the linear polarizers 112C-1 and 112C-2, one or both thereof may be, for example, a linear polarizer formed of a photonic crystal. Further, as to the linear polarizers 112C-1 and 112C-2, one or both thereof may be a wire-grid type linear polarizer, for example. Such a wire-grid type linear polarizer is a polarizer formed by periodically arranging thin metal wire.

The imaging element 113-1 and 113-2 each convert an optical image into an electrical signal, and is the same as the imaging element 113 of the fourth embodiment. One imaging element 113-1 is arranged so that one light beam having been separated by the beam splitter BS enters through one linear polarizer 112C-1. The other imaging element 113-2 is arranged so that the other light beam having been separated by the beam splitter BS enters through the other linear polarizer 112C-2.

The imaging section 11F and the imaging device 1 of the ninth embodiment each are provided with two linear polarizers 112C-1 and 112C-2, whereby stray lights having polarized lights at right angels to each main axis of the linear polarizers 112C-1 and 112C-2 can be reduced. Therefore, in the imaging section 11F and the imaging device of the ninth embodiment, the intensity of stray light reaching the imaging elements 113-1 and 113-2 is more effectively reduced. Thus, information on an original subject optical image can be obtained more appropriately.

Herein, the imaging section 11F of the present embodiment was constituted by two linear polarizers 112C-1 and 112C-2, however it can be constituted by more than 2 linear polarizers.

Herein, it is desirable to arrange the linear polarizers such that transmission axes have identical angles between them, which angle is has a value of a quotient of 180 degrees divided by the number of the transmission axis directions of linear polarizers as follows: for example, when the transmission axes of the linear polarizers are in two directions, the transmission axes each are allowed to intersect at about 90 degrees; when the transmission axes of the linear polarizers are in three directions, the transmission axes each are allowed to intersect at about 60 degrees (at about 60 degrees and about 120 degrees); and when the transmission axes of the linear polarizers are in four directions, the transmission axes each are allowed to intersect at about 45 degrees (at about 45 degrees, about 90 degrees, about 135 degrees, and about 180 degrees). Thus, regardless of the polarization state of stray light, the transmission axis of a linear polarizer can approximately be arranged at right angles to the polarization direction of stray light, whereby stray light intensity can effectively be reduced.

In each of the imaging sections 11A-11F of the fourth-ninth embodiments, on the image side of the imaging optical systems 111A or 111B, for example an optical filter such as a low-pass filter or an infra-red cut filter may be arranged depending, for example, on the intended purpose and the constitution of the imaging element 113 or the imaging device 1.

Further, in each of the imaging sections 11A-11F of the fourth-ninth embodiments, the second lens L2 on which the above thin film FL is formed may be a glass lens or a resin material lens. In such a case, with regard to the thin film FL, following Conditional Expressions (1) and (2) are preferably satisfied, assuming the incidence angle of light to a thin film FL to be α [°]; the reflectance of s-polarized light to be Rs(α) [°] in the case of entering the thin film FL at a incidence angle of light α [°]; and the reflectance of p-polarized light to be Rp(α) [°] in the case of entering the thin film at a incidence angle of light α [°].

1 [%]≦Rs(α)−Rp(α) (1)

40 [°]<α<60 [°] (2)

Under the condition where the incidence angle of light α is more than 40 degrees, when the difference between p-polarized light and s-polarized light in reflectance is not less than 1%, stray light intensity can be effectively reduced by a polarizer while the thin film FL can be formed as easy as an existing thin film. On the other hand, under the condition where the incidence angle of light α is less than 60 degrees, when the difference between p-polarized light and s-polarized light in reflectance is not less than 1%, stray light intensity also can be effectively reduced by the polarizer while the thin film FL can be formed as easy as the existing thin film.

Generally, the reflectance of a thin film on a resin material lens is larger than that of a glass lens. Therefore, it has been difficult to use a resin material lens in order to prevent stray light. However, due to the above constitution of each of the imaging sections 11A-11F and the imaging device 1, even when a resin material lens is used as the second lens L2 on which the thin film FL is formed, stray light resulting from the resin material lens can be reduced. Therefore, use of a resin material lens reduces cost, and the imaging section 11A and the imaging device 1, which are resistant to stray light, can be realized.

In such a case, the thin film FL more preferably satisfies following Conditional Expressions (1′) and (2′).

1.2 [%]≦Rs(α)−Rp(α) (1′)

40 [° <α<60 [°] (2′)

When the Conditional Expressions (1′) and (2′) are satisfied, stray light can be more effectively reduced. And thereby, original image information can be obtained mach more appropriately.

Further, in such a case, the thin film FL still more preferably satisfies following Conditional Expressions (1″) and (2″).

1.5 [%]≦Rs(α)−Rp(α) (1″)

40 [°]<α<60 [°] (2″)

When the Conditional Expressions (1″) and (2″) are satisfied, stray light can be still more effectively reduced. And thereby, original image information can be obtained much more appropriately.

Still further, in such a case, in the imaging optical system 111, of the lenses (the fast lens L1, the third lens L3, and the fourth lens L4) other than the second lens L2 on which the thin film FL is formed, one or more of the lenses may be a resin material lens.

Still more further, in each of the imaging sections 11A-11F of the fourth-ninth embodiments, the thin film FL preferably satisfies following Conditional Expressing (3) at the reference wavelength of the imaging element 113, assuming the reflectance of p-polarized light to be Rp(α) [%] in the case of entering a thin film FL at a incidence angle of light of 50 [°].

Rp(50)<1.5 [%] (3)

Usually, in a thin film, when the reflectance of p-polarized light is decreased, the reflectance of s-polarized light tends to be increased. Each of the imaging sections 11A-11F and the imaging device I of the above described constitution is provided with a linear polarization section 112A, 112B, or 112C, whereby stray light of s-polarized light can be reduced by a linear polarizer having the main axis in a direction differing from that of the s-polarized light. Thus, the reflectance of p-polarized light can be decreased. Further, in each of the imaging sections 11A-11F and the imaging device 1 of the constitution, the reflectance of p-polarized light of the thin film FL is less than 1.5% at the reference wavelength which is most critical in the imaging element 113, whereby stray light on a photographed image can be effectively reduced.

The reflectance of p-polarized light needs to be reduced with respect to, for example, a reference wavelength of 550 nm when imaging visible light images and with respect to, for example, a reference wavelength of 900 nm when imaging near infrared images. Herein, the reference wavelength is equivalent to the center wavelength of the imaging light of an imaging element, being set individually by each sensor maker. Usually, the light receiving sensitivity of the imaging element is most excellent at the reference wavelength.

In such a case, the thin film FL more preferably satisfies following Conditional Expression (3′).

Rp(50)<1.0 [%] (3′)

When Conditional Expression (3′) is satisfied, stray light can be more effectively reduced. Thus, original image information can be obtained more appropriately.

In such a case, the thin film FL still more preferably satisfies following Conditional Expression (3″).

Rp(50)<0.5 [%] (3″)

When Conditional Expression (3″) is satisfied, stray light can be still more effectively reduced. Thus, original image information can be obtained more appropriately.

Further, in each of the imaging sections 11A-11F of the fourth-ninth embodiments, the thin film FL preferably satisfies above Conditional Expression (3) in a wavelength range of 450 nm-650 nm with respect to the reflectance of p-polarized light, more preferably satisfies above Conditional Expression (3′), and still more preferably satisfies above Conditional Expression (3″).

Each of the imaging sections 11A-11F and the imaging device 1 of the above described constitution is provided with a linear polarization section 112A, 112B, or 1120, whereby stray light of s-polarized light can be reduced by a linear polarizer having the main axis in a direction different from that of the s-polarized light. Thus, the reflectance of p-polarized light can be decreased. Further, in each of the imaging sections 11A-11F and the imaging device 1 of the constitution, the reflectance of p-polarized light of the thin film FL is less than 1.5% in the approximate visible range, whereby the strength of the stray light is reduced regardless of the wavelength of stray light. As a result, regardless of the type of a light source, a clear image (a sharp image) can be obtained.

Next, examples of the thin film FL (FLA-FLA) will now be described.

### First Example of Thin Film FL

A thin film FLA of a first example is an anti-reflection film having a 7-layered constitution with respect to a light of a designed center wavelength λ₀ of 550 nm, and was constituted in such that a first layer through a seventh layer were sequentially layered each employing the material and the optical film-thickness shown in Table 1. Herein, in Table 1, ZrTiO₄ is an “OH-5” (produced by Optron Co., Ltd.), which is the same as in Table 2 and Table 3.

TABLE 1

| | Material | Optical Film-Thickness |
|---|---|---|
| Incident Medium | Air | |
| 7th layer | MgF₂ | 0.25509λ₀ |
| 6th layer | ZrTiO₄ | 0.18248λ₀ |
| 5th layer | MgF₂ | 0.02984λ₀ |
| 4th layer | ZrTiO₄ | 0.22927λ₀ |
| 3dr layer | Al₂O₃ | 0.32406λ₀ |
| 2nd layer | MgF₂ | 0.09375λ₀ |
| 1st layer | Al₂O₃ | 0.52167λ₀ |
| Emission Medium | BK7 | |

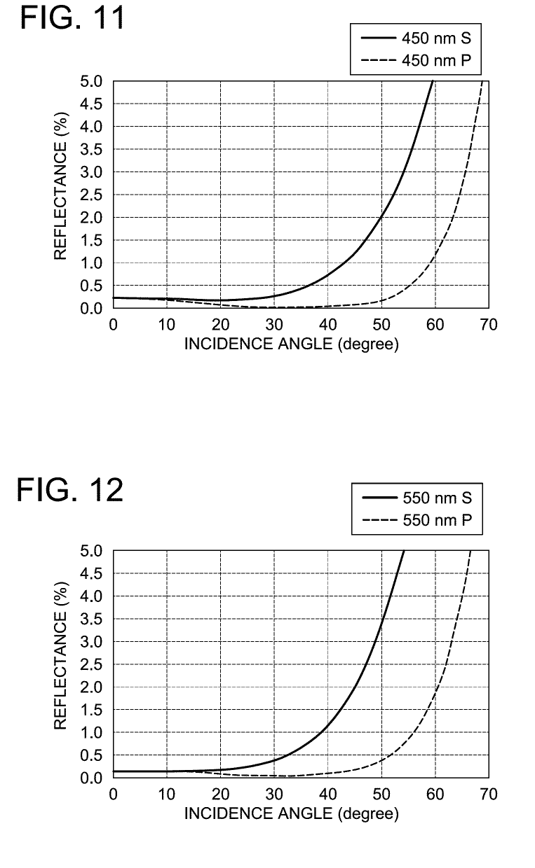

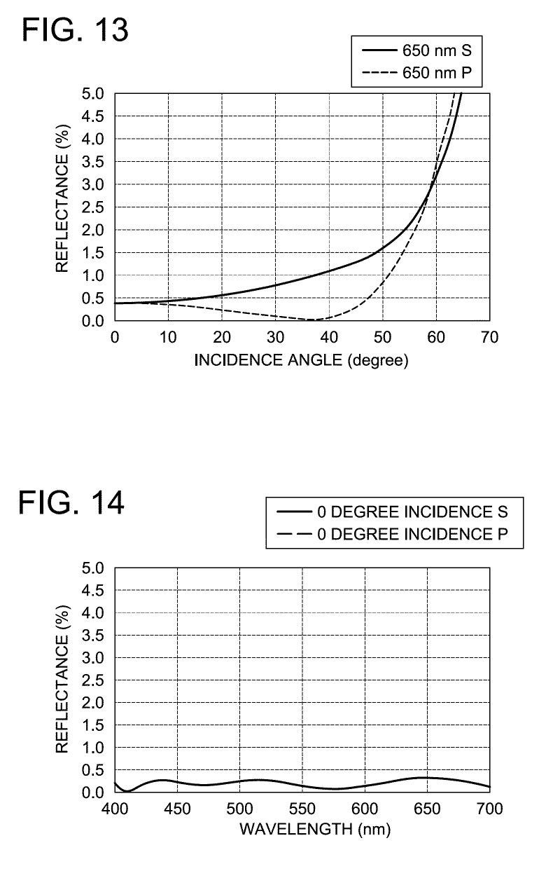

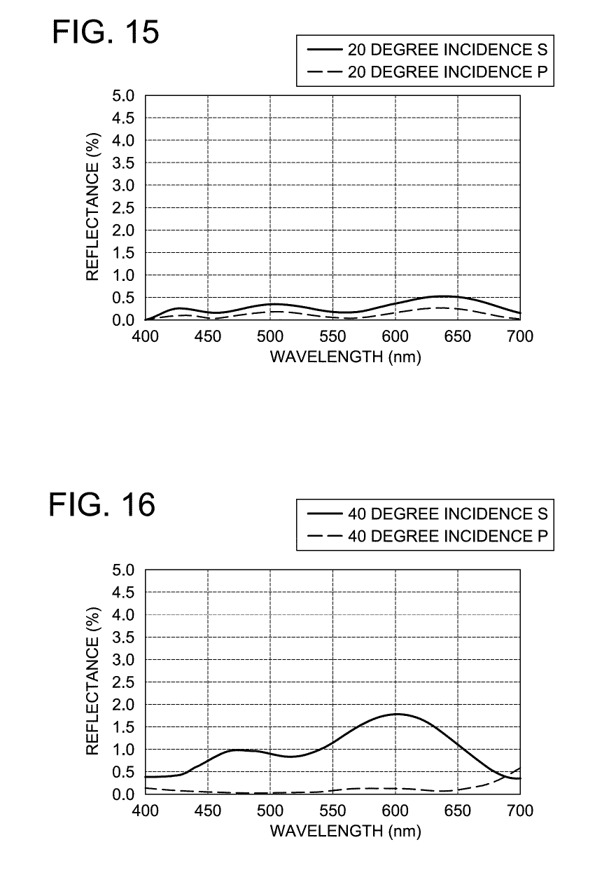

FIG. 11-FIG. 13 are each a figure showing reflection characteristics with respect to an incident angle into the thin film of the first example. FIG. 11 shows the case of an incident light wavelength of 450 nm and FIG. 12 shows the case of an incident light wavelength of 550 nm. FIG. 13 shows the case of an incident light wavelength of 650 nm. The horizontal axis of each of FIG. 11-FIG. 13 represents the incident light angle in degree. The vertical axis thereof represents the reflectance in percent. The solid line represents s-polarized light and the dashed line represents p-polarized light. FIG. 14-FIG. 16 are each a figure showing reflection characteristics, of the thin film of the first example, with respect to a wavelength. FIG. 14 shows the case of a incidence angle of light of 0 degree into the thin film FLA, and FIG. 15 shows the case of a incidence angle of light of 20 degrees into the thin film FLA. FIG. 16 shows the case of a incidence angle of light of 40 degrees into the thin film FLA. The horizontal axis of each of FIG. 14-FIG. 16 represents the wavelength in nm. The vertical axis thereof represents the reflectance in percent. The solid line represents s-polarized light, and the dashed line represents p-polarized light.

The reflection characteristics of the thin film FL designed in such a manner are shown in FIG. 11-FIG. 16. As obvious from FIG. 11-FIG. 16, at a wavelength of 550 nm, when the incidence angle of light into the thin film FLA is 40 [°]-60 [°], the difference in reflectance between s-polarized light and p-polarized light is not less than 10 [%], and the reflectance of p-polarized light is not more than 1.0 [%] in the approximate visible range of a wavelength of 450 nm-650 nm, when the incidence angle of light into the thin film FLA is 50 [°].

### Second Example of Thin Film FL

A thin film FLB of a second example is an anti-reflection film having a 4-layered constitution with respect to a light of a designed center wavelength λ₀ of 850 nm, and was constituted in such that a first layer through a fourth layer were sequentially layered each employing the material and the optical film-thickness shown in Table 2.

TABLE 2

| | Material | Optical Film-Thickness |
|---|---|---|
| Incident Medium | Air | |
| 4th layer | MgF₂ | 0.33211λ₀ |
| 3dr layer | ZrTiO₄ | 0.54167λ₀ |
| 2nd layer | Al₂O₃ | 0.03021λ₀ |
| 1st layer | MgF₂ | 0.43841λ₀ |
| Emission Medium | BK7 | |

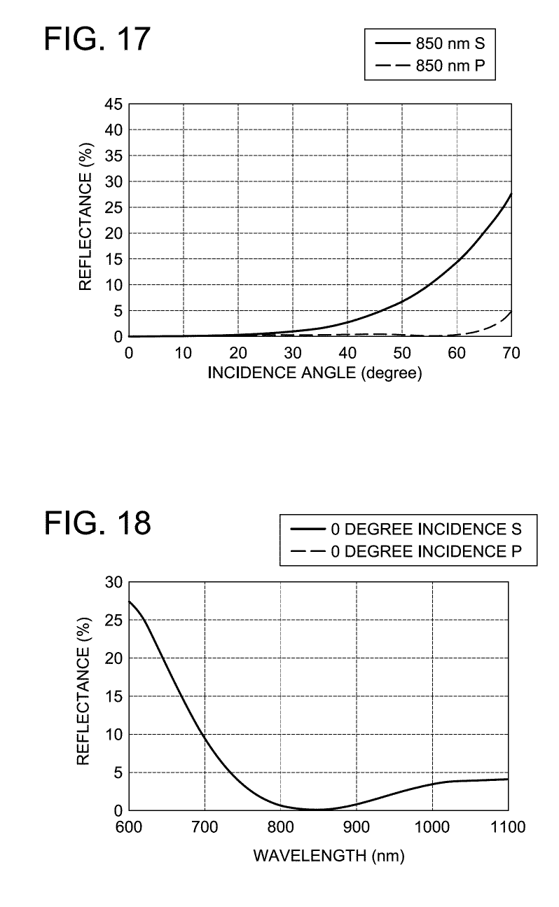

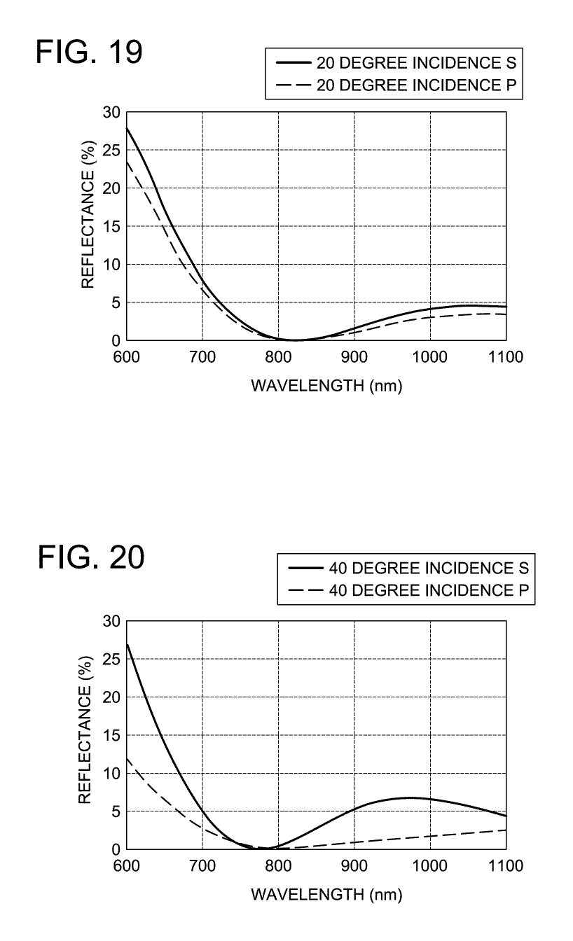

FIG. 17 is a figure showing reflection characteristics with respect to an incident angle into the thin film of the second example. FIG. 17 shows the case of an incident light wavelength of 850 nm. The horizontal axis of each of FIG. 17 represents the incident light angle in degree. The vertical axis thereof represents the reflectance in percent. The solid line represents s-polarized light and the dashed line represents p-polarized light. FIG. 18-FIG. 20 are each a figure showing reflection characteristics, of the thin film of the second example, with respect to a wavelength. FIG. 18 shows the case of a incidence angle of light of 0 degree into the thin film FLB, and FIG. 19 shows the case of a incidence angle of light of 20 degrees into the thin film FLB. FIG. 20 shows the case of a incidence angle of light of 40 degrees into the thin film FLB. The horizontal axis of each of FIG. 18-FIG. 20 represents the wavelength in nm. The vertical axis thereof represents the reflectance in percent. The solid line represents s-polarized light, and the dashed line represents p-polarized light.

The reflection characteristics of the thin film FLB designed in such a manner are shown in FIG. 17-FIG. 20. As obvious from FIG. 17-FIG. 20, for an infrared light at a designed center wavelength of 850 nm, when the incidence angle of light into the thin film FLB is 40 [°]-60 [°], the difference in reflectance between s-polarized light and p-polarized light is not less than 2.0 [%], and the reflectance of p-polarized light is not more than 0.2 [%] in the approximate visible range of a wavelength of 850 nm, when the incidence angle of light into the thin film FLB is 50 [°].

### Third Example of Thin Film FL

A thin film FLC of a first example is an anti-reflection film having a 3-layered constitution with respect to a light of a designed center wavelength λ₀ of 550 nm, and was constituted in such that a first layer through a third layer were sequentially layered each employing the material and the optical film-thickness shown in Table 3.

TABLE 3

| | Material | Optical Film-Thickness |
|---|---|---|
| Incident Medium | Air | |
| 3dr layer | Al₂O₃ | 0.36167λ₀ |
| 2nd layer | MgF₂ | 0.36169λ₀ |
| 1st layer | ZrTiO₄ | 0.45592λ₀ |
| Emission Medium | BK7 | |

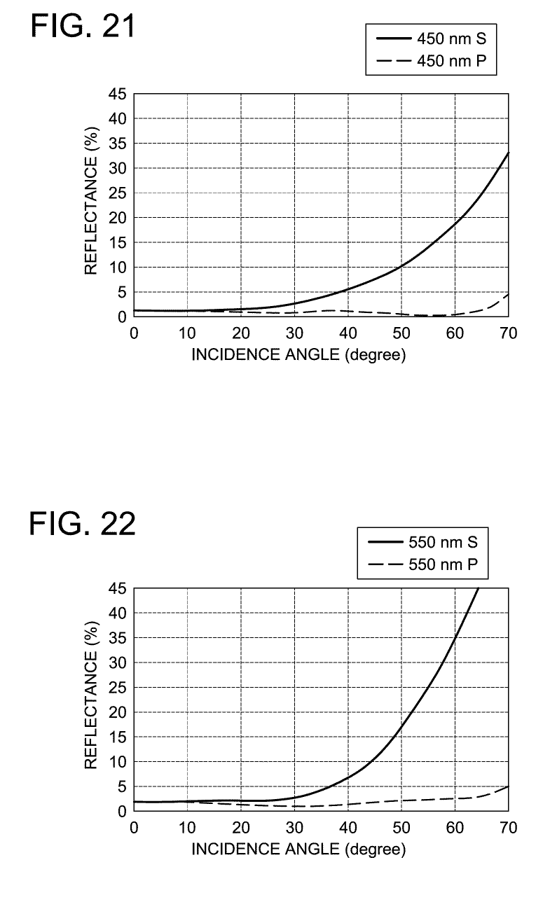

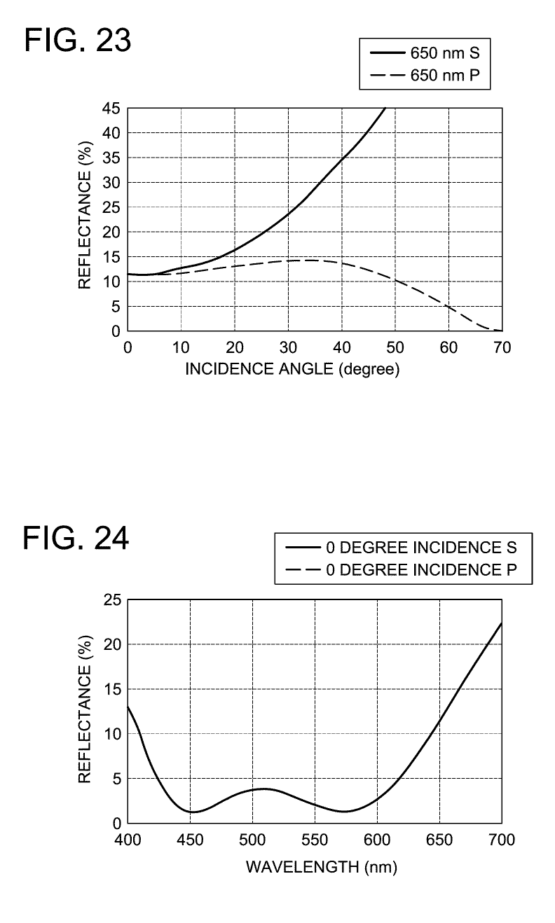

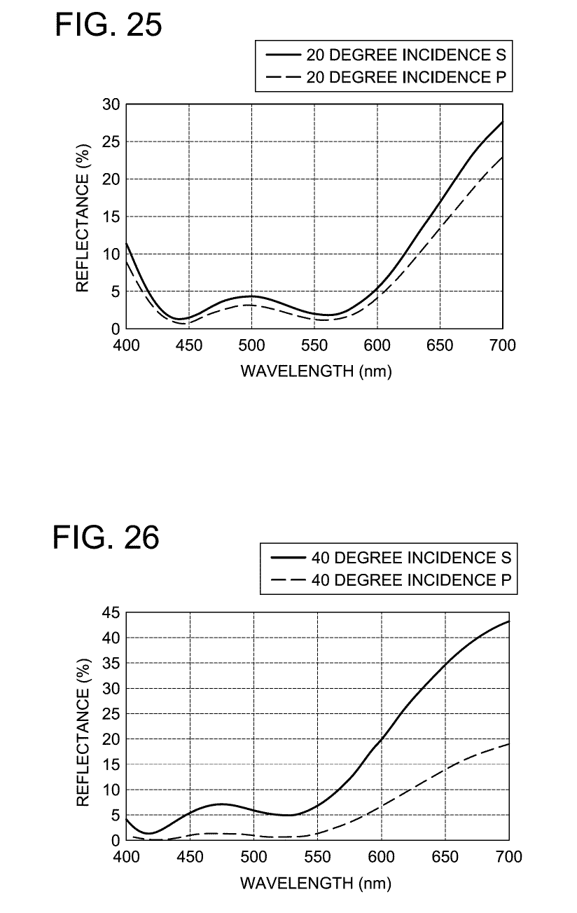

FIG. 21-FIG. 23 are each a figure showing reflection characteristics with respect to an incident angle into the thin film of the third example. FIG. 21 shows the case of an incident light wavelength of 450 nm and FIG. 22 shows the case of an incident light wavelength of 550 nm. FIG. 23 shows the case of an incident light wavelength of 650 nm. The horizontal axis of each of FIG. 21-FIG. 23 represents the incident light angle in degree. The vertical axis thereof represents the reflectance in percent. The solid line represents s-polarized light and the dashed line represents p-polarized light. FIG. 24-FIG. 26 are each a figure showing reflection characteristics, of the thin film of the third example, with respect to a wavelength. FIG. 24 shows the case of a incidence angle of light of 0 degree into the thin film FLC, and FIG. 25 shows the case of a incidence angle of light of 20 degrees into the thin film FLC. FIG. 26 shows the case of a incidence angle of light of 40 degrees into the thin film FLC. The horizontal axis of each of FIG. 24-FIG. 26 represents the wavelength in nm. The vertical axis thereof represents the reflectance in percent. The solid line represents s-polarized light, and the dashed line represents p-polarized light.

The reflection characteristics of the thin film FL designed in such a ma rarer are shown in FIG. 21-FIG. 26. As obvious from FIG. 21-FIG. 26, for a approximately visible light at a wavelength of 450-650 nm, when the incidence angle of light into the thin film FLC is 40 [°]-60 [°], the difference in reflectance between s-polarized light and p-polarized light is not less than 4.0 [%] incidence angle of light.

### Fourth Example of Thin Film FL

A thin film FLD of a fourth example is an anti-reflection film having a 4-layered constitution with respect to a light of a designed center wavelength λ₀ of 550 nm, and was constituted in such that a first layer through a fourth layer were sequentially layered, on a substrate of ZEONEX (trademark) E48R each employing the material and the optical film-thickness shown in Table 4. Herein, in Table 1, ZrTiO₄ is an “OH-5” (produced by Optron Co., Ltd.), which is the same as in Table 2 and Table 3.

TABLE 4

| | Material | Optical Film-Thickness |
|---|---|---|
| Incident Medium | Air | |
| 4th layer | SiO₂ | 0.22564λ₀ |
| 3dr layer | TiO₂ | 0.46909₀ |
| 2nd layer | SiO₂ | 0.07964λ₀ |
| 1st layer | TiO₂ | 0.05864λ₀ |
| Emission Medium | E48R | |

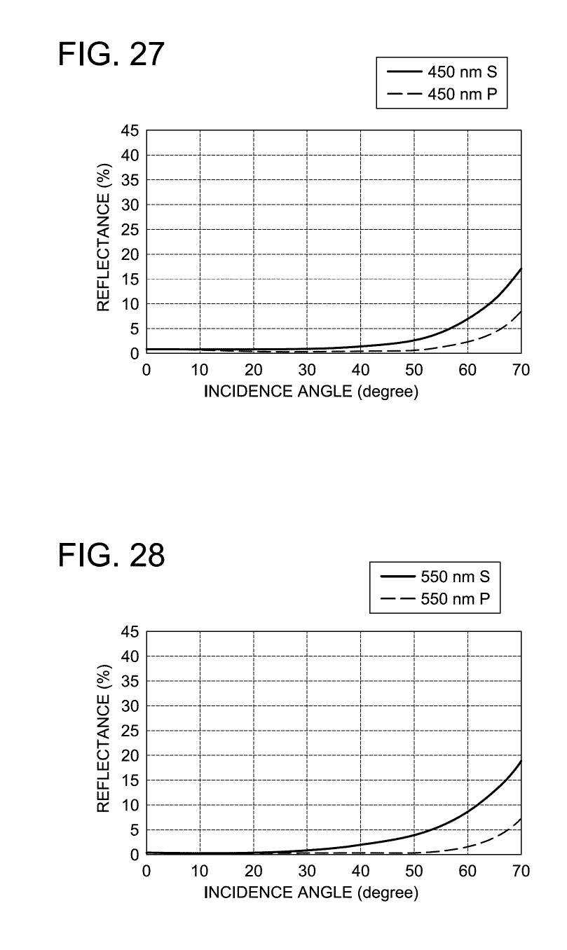

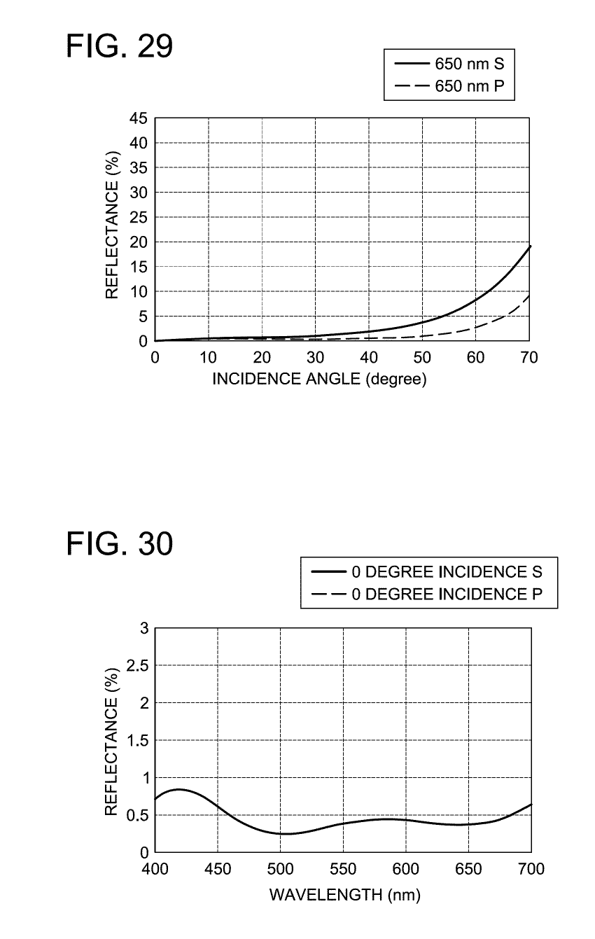

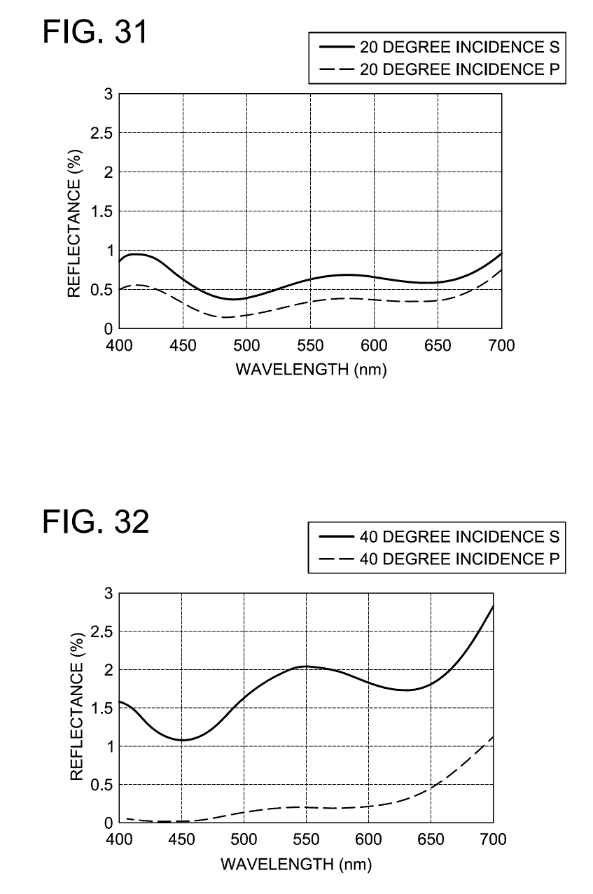

FIG. 27-FIG. 29 are each a figure showing reflection characteristics with respect to an incident angle into the thin film of the fourth example. FIG. 28 shows the case of an incident light wavelength of 450 nm and FIG. 28 shows the case of an incident light wavelength of 550 nm. FIG. 29 shows the case of an incident light wavelength of 650 nm. The horizontal axis of each of FIG. 27-FIG. 29 represents the incident light angle in degree. The vertical axis thereof represents the reflectance in percent. The solid line represents s-polarized light and the dashed line represents p-polarized light. FIG. 30-FIG. 32 are each a figure showing reflection characteristics, of the thin film of the fourth example, with respect to a wavelength. FIG. 30 shows the case of a incidence angle of light of 0 degree into the thin film FLD, and FIG. 31 shows the case of a incidence angle of light of 20 degrees into the thin film FLD. FIG. 32 shows the case of a incidence angle of light of 40 degrees into the thin film FLD. The horizontal axis of each of FIG. 30-FIG. 32 represents the wavelength in nm. The vertical axis thereof represents the reflectance in percent. The solid line represents s-polarized light, and the dashed line represents p-polarized light.

The reflection characteristics of the thin film FLD designed in such a manner are shown in FIG. 27-FIG. 29. As obvious from FIG. 27-FIG. 32, for an approximately visible light at a wavelength of 450-650 nm, when the incidence angle of light into the thin film FLD is 40 [°]-60 [°], the difference in reflectance between s-polarized light and p-polarized light is not less than 1.0 [%], and the reflectance of p-polarized light is not more than 1.0 [%] in the approximate visible range of a wavelength of 450 nm-650 nm, when the incidence angle of light into the thin film FLD is 50 [°].

Next, the case in which the above imaging device 1 is mounted in a vehicle for forward-direction imaging or backward-direction imaging will be described.

(The Case of Forward-Direction Imaging)

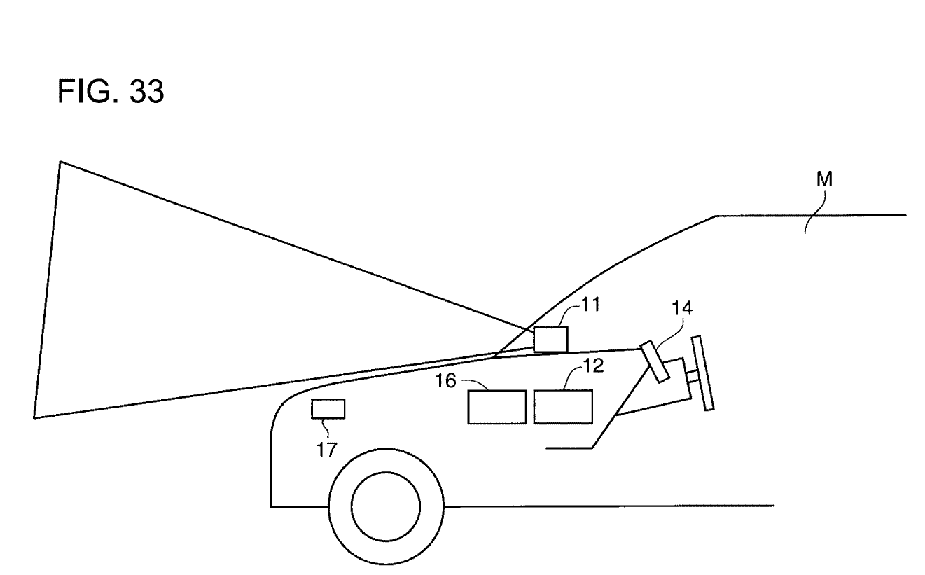

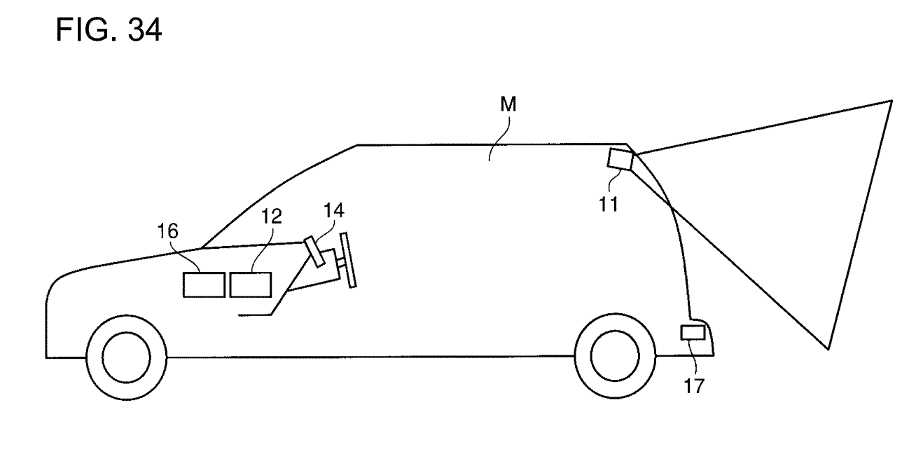

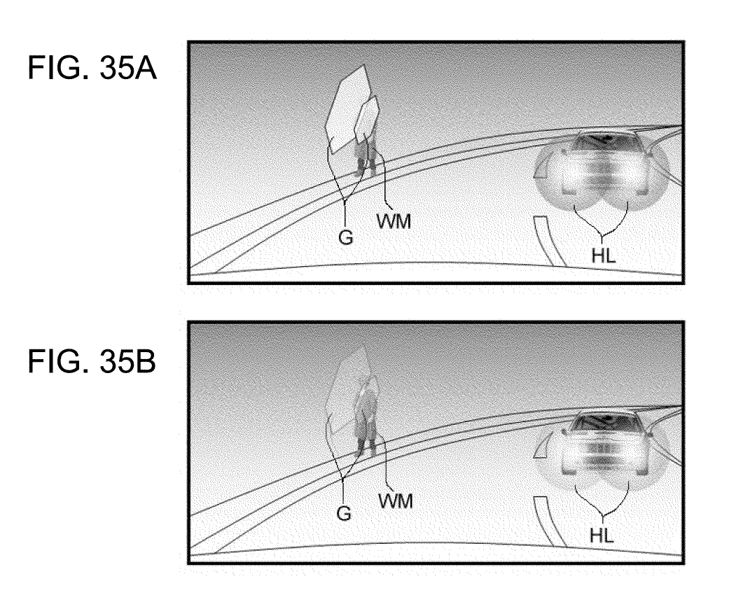

FIG. 33 is a schematic view showing the constitution of an imaging device mounted in a vehicle in the case of forward-direction imaging. FIG. 34 is a schematic view showing the constitution of an imaging device mounted in a vehicle in the case of backward-direction imaging FIGS. 35A and B are views showing, as an example, a normal image generated by the normal mode and a polarized light component reduced image generated by the polarized light component reduction mode. FIG. 35A shows the normal image, and FIG. 35B shows the polarized light component reduced image.

In the case of forward-direction imaging, for example, as shown in FIG. 33, an imaging device 1 is used as a monitoring camera to monitor a specific area by imaging a subject in the specific area ahead of the vehicle M. The imaging section 11 is mounted, for example, on the dashboard at the front so as to image in the forward direction of the vehicle M. Then, an image of the subject having been imaged is displayed on a display section 14 placed, for example, on the front panel. The image displayed on the display section 14 is can be either a normal image or a polarized light component reduced image depending on the situation, in which based on a mode signal of a mode signal generation section 17 arranged in the front portion of the vehicle, for example, near the front bumper, as described above, the mode of an image processing section 12 is switched by a control section 16, and then either a normal image or a polarized light component reduced image is formed by the image processing section 12 based on the situation. Switching from the normal mode to the polarized light component reduction mode is carried out, for example, when light quantity is larger than a specific threshold value and when a spot light source is detected, as well as the case of the night time zone.

Herein, the display section 14 may be also used as a monitor in a so-called car navigation system. Further, for example, projection may be carried out to the front glass by a so-called head-up display. The mode signal generation section 17 may be arranged in the dashboard from the viewpoint of reducing the effect of the head light of an oncoming vehicle.

On the other hand, in the case of backward-direction imaging, for example, as shown in FIG. 34, an imaging device 1 is used as a monitoring camera to monitor a specific area by imaging a subject in the specific area behind the vehicle M. The imaging section 11 is arranged, for example, on a ceiling portion in the rear for imaging in the backward direction of the vehicle M. Then, an image of the subject having been imaged is displayed on a display section 14 placed, for example, on the front panel. The image displayed on the display section 14 can be either a normal image or a polarized light component reduced image depending on the situation, where the mode of an image processing section 12 is switched, by a control section 16, based on a mode signal of a mode signal generation section 17 arranged in the rear portion of the vehicle, for example, near the rear bumper, as described above.

In the imaging device 1 mounted in the vehicle, a ghost G of the headlight HL of an oncoming vehicle is superimposed on a normal image as shown in FIG. 35A. When this ghost is superimposed on a pedestrian WM, the pedestrian can be hard to be observed. In contrast, in a polarized light component reduced image, the ghost G is reduced as shown in FIG. 35B. Thus, even when the ghost G is superimposed on the pedestrian WM, the pedestrian is easy to be observed.

As described above, according to the present invention, based on a mode signal of the mode signal generation section, the mode control section allows the image generation section to operate in the normal mode or in the polarized light component reduction mode to form a normal image or a polarized light component reduced image in the image generation section. Therefore, in the case of imaging in the situation where stray light having a polarized light component occurs in the imaging device, in other words, when the possibility of occurrence of stray light is large, the imaging device is automatically switched to the polarized light component reduction mode, and then a polarized light component reduced image, in which the occurrence of stray light having a polarized light component is reduced or eliminated, is formed. In contrast, when the possibility of occurrence of stray light is small, the imaging device is automatically switched to the normal mode, and then a normal image, which is more natural than the polarized light component reduced image, is formed. In this way, provided is an imaging device capable of automatically switching whether to reduce stray light or not, depending on the situation.

To express the present invention, the present invention has been described appropriately and sufficiently using the embodiments with reference to the drawings in the above description. It should be understood that the above embodiments can easily be modified and/or improved by those skilled in the art. Therefore, unless modification or improvement conducted by those skilled in the art is departing from the scope of right defined by the accompanied claims, the modified or improved form is included in the scope of right of the claims.

1.-14. (canceled)

15. An imaging device, comprising:
an imaging section configured to have a linear polarization section and to pick up an optical image having a polarized light component having reduced;
an image processing section configured to form an image corresponding to the optical image, based on an output of the imaging section;
a mode signal generation section configured to generate a mode signal for determining a mode of the image to be formed in the image processing section; and
a mode control section configured to control the image processing section:
to separate a non-polarized light component from the output of the imaging section and to form a polarized light component reduced image based on the separated non-polarized light component when the mode signal of the mode signal generation section is judged to indicate a polarized light component reduction mode; and
to form a normal image based on the output of the imaging section without separating the non-polarized light component from the output of the imaging section when the mode signal of the mode signal generation section is judged to indicate a normal mode.

16. The imaging device of claim 15, wherein the mode signal generation section includes an optical sensor for detecting an amount of external light, and the mode control section judges:
that an output value of the optical sensor indicates the polarized light component reduction mode when the output value is less than a predetermined threshold value; and
that the output value of the optical sensor indicates the normal mode when the output value is not less than the predetermined threshold value.

17. The imaging device of claim 15, wherein the mode signal generation section includes a clock section for counting time, and the mode control section judges:
that an output value of the clock section indicates the polarized light component reduction mode when the output value is outside a predetermined time zone; and
that the output value of the clock section indicates the normal mode when the output value is within the predetermined time zone.

18. The imaging device of claim 15, wherein the mode signal generation section includes the imaging section, and the mode control section judges:
that an output value of the imaging section indicates the polarized light component reduction mode when the output value is less than a predetermined threshold value; and
that the output value of the imaging section indicates the normal mode when the output value is not less than the predetermined threshold value.

19. The imaging device of claim 15, wherein the imaging section includes:
an imaging optical system configured to form the optical image on a predetermined image plane;
a linear polarizer provided at a position on an optical axis of the imaging optical system to allow incoming light to pass therethrough and emit therefrom with respect to a plurality of transmission axes which are different from each other;
an imaging element which is provided such that a light receiving surface of the imaging element is located in a vicinity of the predetermined image plane, and which is configured to convert the optical image into an electrical signal.

20. The imaging device of claim 15, wherein the linear polarization section includes a plurality of linear polarizers on the same plane, and the linear polarizers have different transmission axes.

21. The imaging device of claim 20, wherein one of the plurality of linear polarizers is constituted by a photonic crystal.

22. The imaging device of claim 15, wherein the imaging optical system is provided with a thin film whose p-polarization reflectance and s-polarization reflectance are different, on an upstream side from the linear polarizer in a progressing direction of light.

23. The imaging device of claim 22, wherein the thin film is disposed on a surface on which a strong stray light which reaches the imaging element is reflected.

24. The imaging device of claim 22, wherein the imaging optical system includes at least a lens, and the thin film is disposed on the lens and satisfies the following conditional expressions (1) and (2):
1 [%]≦Rs(α)−Rp(α) (1)
40 [°]<α<60 [°] (2)
where:
α [°] is an incidence angle of light with respect to the thin film;
Rs(α) [%] is an s-polarization reflectance of the thin film when entering the thin film at the incidence angle α [°] of light; and
Rp(α) [%] is a p-polarization reflectance of the thin film when entering the thin film at the incidence angle α [°] of light.

25. The imaging device of claim 22, wherein the thin film satisfies the following conditional expression (3) at a reference wavelength of the imaging element:
Rp(50)<1.5 [%] (3)
where:
Rp(50) [%] is a p-polarization reflectance of the thin film when entering the thin film at the incidence angle α [°] of light.

26. The imaging device of claim 22, wherein the p-polarization reflectance of the thin film satisfies the following conditional expressions (3) in a wavelength range of 450 nm to 650 nm:
Rp(50)<1.5 [%] (3)
where:
Rp(50) [%] is a p-polarization reflectance of the thin film when entering the thin film at the incidence angle α [°] of light.

27. The imaging device of claim 20, wherein the imaging element and the linear polarizer constitute a polarization imaging system, being stacked to each other in an integrated manner.

28. The imaging device of claim 15, wherein the imaging section is one of a car-mounted camera, a surveillance camera, and a measurement camera.
